(19) United States
(12) Patent Application Publication
(10) Pub. No.: US 2018/0053227 A1
(43) Pub. Date: Feb. 22, 2018

(54) ESTABLISHING COMMUNICATIONS WITH OPTIMAL ELECTRONIC DEVICE

(71) Applicant: 10 Minute Realty, LLC, Sugar Land, TX (US)

(72) Inventors: Rina Esquenazi Camhi, Houston, TX (US); Edit Szamos Styve, Sugar Land, TX (US)

(21) Appl. No.: 15/679,075

(22) Filed: Aug. 16, 2017

Related U.S. Application Data
(60) Provisional application No. 62/376,296, filed on Aug. 17, 2016.

(51) Int. Cl. G06Q 30/02; G06Q 50/16; H04W 4/02

(52) U.S. Cl. CPC G06Q 30/0281; H04W 4/028; G06Q 50/16

(57) ABSTRACT

A system and method for providing a fast and efficient way to enable a user to locate and identify one or more real estate agents who are immediately available to provide the user prompt access real estate properties, thereby significantly reducing wait times.

### CROSS-REFERENCE TO RELATED APPLICATION

This application claims priority benefit to U.S. provisional application No. 62/376,296, entitled Establishing Communications between Electronic Devices, and filed on Aug. 17, 2016, the contents of which are entirely incorporated herein.

### TECHNICAL FIELD

Embodiments described herein generally relate to systems and methods for establishing communications between electronic devices and more specifically, to locating an optimal second device for a first device from amongst a plurality of potential second devices, and establishing communications between the first device and the optimal second device.

### BRIEF DESCRIPTION OF THE DRAWINGS

Implementations of the present technology will now be described, by way of example only, with reference to the attached figures, wherein:

FIG. 1 is a flow diagram illustrating a method of locating a real estate agent to provide a showing according to one embodiment;

FIG. 2 is a diagram illustrating an agent login screen according to one embodiment;

FIG. 3 is a diagram illustrating an agent application menu according to one embodiment;

FIG. 4 is a diagram illustrating an agent pending requests screen according to one embodiment;

FIG. 5 is a diagram illustrating an agent request action screen according to one embodiment;

FIG. 6 is a diagram illustrating an agent customer confirmation according to one embodiment;

FIG. 7 is a diagram illustrating an agent active request screen according to one embodiment;

FIG. 8A is a diagram illustrating an agent profile screen according to one embodiment;

FIG. 8B is a diagram illustrating an agent profile screen according to one embodiment;

FIG. 9 is a diagram illustrating an agent settings screen according to one embodiment;

FIG. 10 is a diagram illustrating an agent feedback screen according to one embodiment;

FIG. 11 is a diagram illustrating a client Instant Showing screen prior to login according to one embodiment;

FIG. 12 is a diagram illustrating a reverse geocoding screen before login according to one embodiment;

FIG. 13A is a diagram illustrating a customer login screen according to one embodiment;

FIG. 13B is a diagram illustrating a customer profile screen according to one embodiment;

FIG. 13C is a diagram illustrating a customer profile screen according to one embodiment;

FIG. 13D is a diagram illustrating an agent screen according to one embodiment;

FIG. 13E is a diagram illustrating an agent screen according to one embodiment;

FIG. 13F is a diagram illustrating an agent screen according to one embodiment;

FIG. 14 is a diagram illustrating a screen for finding a real estate agent in a neighborhood according to one embodiment;

FIG. 15 is a diagram illustrating an active request for a showing according to one embodiment;

FIG. 16A is a diagram illustrating a confirmed found realtor screen according to one embodiment;

FIG. 16B is a diagram illustrating a confirmed found realtor screen according to one embodiment;

FIG. 17 is a diagram illustrating menu screen according to one embodiment;

FIG. 18 is a diagram illustrating a user profile screen according to one embodiment;

FIG. 19A is a diagram illustrating a user feedback screen according to one embodiment;

FIG. 19B is a diagram illustrating a user feedback screen according to one embodiment;

FIGS. 20A-20D illustrate a sequence diagram corresponding to a method of locating a real estate agent according to one embodiment;

FIG. 20E is a diagram illustrating a customer screen according to one embodiment;

FIG. 20F is a diagram illustrating a customer screen according to another embodiment;

FIG. 20G is a diagram illustrating a customer screen showing no realtors available according to one embodiment;

FIG. 21 is a block diagram illustrating an electronic device according to one embodiment;

FIG. 22 is a diagram illustrating a system-control unit for an electronic device according to one embodiment.

FIG. 23A is a diagram illustrating a landing screen for a real estate agent application according to one embodiment.

FIG. 23B is a diagram illustrating a landing screen for a buyer or renter application according to one embodiment.

FIG. 24 is a diagram illustrating a computing device for use with techniques described herein according to one embodiment.

FIG. 25 is a block diagram illustrating a computing device for use with techniques described herein according to another embodiment.

FIG. 26 is a diagram illustrating a network of programmable devices according to one embodiment.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment. For simplicity and clarity of illustration, where appropriate, reference numerals have been repeated among the different figures to indicate corresponding or analogous elements. Also, the description is not to be considered as limiting the scope of the implementations described herein.

As used herein, the term “a programmable device” may refer to a single programmable device or a plurality of programmable devices working together to perform the function described as being performed on or by a programmable device. Similarly, “a machine-readable medium” may refer to a single physical medium or a plurality of media that together may store the material described as being stored on the machine-readable medium.

As used herein, the term “coupled” may refer to a component, which is directly or indirectly connected to one or more components. “Coupled” may refer to components and/or devices, which are in signal communication with one another.

As used herein, the term “server” may refer to a hardware server and/or a virtual machine.

As used herein, term “client” or “client device” may refer to a device used by a person/user such as a real estate agent, a buyer or a renter of real estate property such as, for example, a building or a house, to search for a real estate property using one or more applications loaded on a client device.

As used herein, the term “real estate agent” may refer to a person or party who is authorized within a jurisdiction to sell real estate property.

As used herein, the term “user” may refer to a buyer or renter of real-estate, a potential buyer or renter of real-estate, a real estate agent and/or a potential real estate agent.

As used herein, the term “showing” or “show” can refer to viewing a real-estate property by a buyer or renter and/or real estate agent that is facilitated by a real estate agent.

In one embodiment, the present technology may be implemented in software or hardware, or both. In one embodiment, the present technology may include one or more processors to execute instructions for implementing one or more steps associated with providing buyers or renters of real-estate property with access to real estate agents to view active listings of real-estate properties. The software to implement embodiments of the invention described herein may be stored within a memory device or other storage device, such as for example, a non-transitory program storage device.

Embodiments disclosed herein are configured to provide a fast and efficient way to enable a user, for example a user-purchaser to locate and identify a real estate agent who may be able to show one or more real estate properties that the user would like to view. The one or more properties may be determined using user-defined search criteria using an application or applications that may be stored on a user client device or on a server that may be accessible by a user-purchaser over a network. In an embodiment, the user-purchaser may also select one or more real estate agents using user-defined criteria to enable the user-purchaser to view a home or property from the identified properties. In one embodiment, the user may be presented with a real estate agent who may be able to arrive at a location chosen by a user within a predetermined set time. The location may correspond to the home or property that the user would like to view. The predetermined set time may, for example, be ten minutes, twenty minutes, thirty minutes or another suitable length of time as selected by the user or the real estate agent. In at least one embodiment, a user may choose or select a real estate agent based on the maximum distance of the real estate agent to the user and/or the location of the home or property. In another embodiment, a user may select a real estate agent based on the maximum amount of time for the real estate agent to travel to the home or property or, alternatively, to the user.

In an embodiment, a software application on a user-purchaser's client device (hereinafter “client device”) may be used to implement the embodiments described herein. The client device may be an electronic device that includes one or more processors and memory. The client device may be configured to store one or more software applications having instructions in memory, for example, a non-transitory programmable storage device. The one or more software applications when executed by some of the one or more processors may be used for identifying one or more properties that the user would like to view as well as selecting real estate agents for showing the property. The client device may be a tablet computer, a smart phone, a personal computer, or the like. In at least one embodiment, the activities of the client devices running such software applications may be tracked and administered by one or more server computers which are in signal communication with such devices. In at least one embodiment, a Software-as-Service model may enable applications to be hosted as a single system, providing services to multiple buyers, agents, brokerage firms and multiple-regional markets. In at least one embodiment, users and firms may sign up through a web or mobile interface and manage their own accounts, located on the one or more server computers, or in a remote device and/or remote server.

In one embodiment, a real estate agent may register via an electronic device to be notified by buyers or renters if certain criteria are met. Registration may be fee based or may be free. In an embodiment, real estate agents may be compensated for successfully rendezvousing with a buyer or renter and/or meeting with a buyer or renter within a predetermined amount of time. In an embodiment, users (e.g., real estate agents, purchasers or renters) may be charged subscription fees for using systems described herein. In an embodiment, subscriptions can include credit card authorization and a checkout process with automatic recurring payments. In an embodiment, real estate agent users may cancel a subscription to a service such as those described herein.

In one embodiment, new users, for example, new user-purchasers or renters of a system or application may be required to register before they may request a showing of a property. Registration is simple and user-friendly. In an embodiment, confirmation of registration is sent to a client device via email. In another embodiment, confirmation of registration may be sent to a client device through a textual (“text”) message. In an embodiment, each user may be provided with a unique login password. Entering the login password may confirm that the user is a properly registered user who is allowed to utilize the systems and applications.

In one embodiment, a user interface (for example a graphical user interface or GUI) of an electronic device may render a dashboard. The dashboard may include a landing screen to provide a general overview and status information to a user, e.g., a real estate agent or a purchaser. The dashboard may orient the user, giving the user a central location from which to access various features. At least one feature is a map. The map may display, in one example, a user-purchaser or renter's current location as well as the location and identities of real estate agents nearby. The map may also display those properties, which have been previously viewed by the user-purchaser or renter. In at least on embodiment, the map may also display the user-purchaser or renter's favorite properties.

In one embodiment, a dashboard may also provide additional functionality with regard to the properties viewed as discussed above. For example, the dashboard may provide a quick link from a map view to display listing information, pictures, and other useful information. The dashboard may include a button bar navigation that can be used to enable a user to filter properties based on criteria such as price, size, and the number of rooms. Button bar navigation may also enable a user to view information such as demographic information and information about schools near a property in question. In at least one embodiment, a dashboard may also enable a user to establish personal information, including home-buying preferences.

In one embodiment, a client device may be enabled to search for homes based on specific keywords. Keyword searching may enable searching based on terms that may not be appropriate to include as filters. Search terms could include, in some non-limiting examples, desert landscape, modern, colonial, custom home, etc. In at least one embodiment, keywords may be used in conjunction with other search criteria, as will be discussed below.

In one embodiment, optional filters may be used to the properties listed to only those that match search criteria including, but not limited to: zip code, price range, square footage, lot size, number of stories, number of bedrooms, number of bathrooms and garage size.

In one embodiment, once a search has been performed using some or all of the criteria and filters described above, a client device may render a list of suitable properties. Results may be displayed as a pinned map or text listing. In at least one embodiment, maps may display the user-purchaser or renter's current location with homes matching search and filter criteria displayed as pins on the map. In at least one embodiment, tapping a pin may cause information and options to be displayed. In at least one embodiment, a map may have auto zoom functionality. Auto zoom functionality enables a device-user to cause a device to display a maximum number of properties, which may prevent the map from becoming cluttered. In one embodiment, this maximum number of displayed properties may be user-selectable. In one embodiment, the mapping function may be configured to auto zoom out in more sparsely populated areas to a maximum level set by either the user, or by the system administrator, as appropriate.

In one embodiment, instead of, or in addition to, providing a map view as described above, a device may also provide textual list view. In such a textual list view, lists of homes may be sorted and presented according to their proximity to the user's current location. As in the map view discussed above, tapping on a list item may cause additional information and options to be displayed.

In one embodiment, a user (for example, a buyer or renter of real-estate) may select a property for an active listing of properties for viewing. Details on the property may subsequently be displayed on the client-device once selected. Once a property has been selected, the user may have the option of displaying additional information about the property, such as seller information, listing price, neighborhood information, or the like. The user may also have the option of adding the selected property to a user's list of favorite properties that may be stored on the client-device or on a server that may be accessed by the client-device. The user may also be given the option of excluding the property from any future searches. In one embodiment, the user may request that the selected property be shown to the user by a real estate agent within a predetermined amount of time, as will be discussed in greater detail below.

In one embodiment, an electronic device may have a route planning feature. A route-planning feature may enable a user (for example, a buyer or renter) to select properties in a specific order and add them to a route plan. Thereafter, driving instructions and timings may be automatically provided to a client device. As properties are updated and/or preferred homes are added to the list of homes for viewing, route plans may change by factoring the device-user location, availability of real estate agents to show properties, approval of real estate agents by the user, and the processor (of the electronic device, for example) may efficiently determine an efficient route to view the properties as homes are added. Adding preferred homes to the viewing may make the processor more efficient in determining an efficient routes.

In one embodiment, an electronic device may have an agent or real estate agent contact list feature. Within the agent contact feature, once real estate agent connects through the system with a user buyer or renter, the agent's name, preferences and contact information are stored in buyer contact list. This may enable user buyers or renters to text, email or call agents directly from the list. This feature may enable a buyer to view a list of properties shown to them by each agent and view any notes taken during any such showings. In one embodiment, the user may be provided with the option of excluding certain agents from receiving showing request notifications.

In one embodiment, a user (for example, a buyer or renter) may request a showing of a selected property by a real estate agent within a predetermined amount of time, (ten to twenty minutes, for example). As discussed above, the user may select the specific property from a pinned map or from a list of those properties nearby using global positioning system (GPS). In an embodiment, a user may be given the option of entering a physical address into the electronic device. In at least one embodiment, once a desired property has been selected, the user may be provided with various options. For example, the user may request an agent. If the user requests an agent, the system may determine or estimate the amount of time it will take for an agent to arrive at the user's location or the location of the selected property. The device may provide this information and request confirmation that the user would like a real estate agent to come to the desired location. For example, an electronic device may display a message such as: “There are 8 agents current within 10 to 20 minutes from here. Would you like to request an agent to come show you the house now?” If the user confirms her desire for a showing, a request will be sent to at least one real estate agent, as will be discussed in detail below.

In one embodiment, once the user (for example, a buyer or renter) confirms the user's desire for a showing, the system will begin to display status updates to the user and begin the process of sending notifications to real estate agents in periodically increasing concentric circles based on the proximity of real estate agents to the user. This process may give the greatest chance to provide the desired showing to those agents closest in proximity, while periodically expanding the radius to include agents farther away. This process may therefore be beneficial to both the user and the real estate agents in question. During the process of sending show-requests to real estate agents, status updates may be provided to the user of the user client device running an application of this disclosure. Example status updates may include: “Checking with agents who are within 10 minutes arrival time . . . ”; (after 30 seconds have elapsed), “Expanding search to agents within 15 minutes arrival time . . . ”; and (after 60 seconds have elapsed), “Expanding search to agents within 20 minutes arrival time . . . ”.

In one embodiment, once a real estate agent confirms the real estate agent's desire to provide the requested showing of a property, the user may receive an updated message indicating that the agent has confirmed that the agent is available to show the property and within the time limit desired by the user. Such a message could include” “[Agent's Name] will arrive in [x] minutes to show you the house at [address].” In at least one embodiment, a picture of the agent and other relevant information may accompany the message. In one embodiment, the buyer may track the agent on a map while the agent is in route. In one embodiment, the user may receive information from multiple agents and may select the preferred agents that the user would like to use to view the property.

In one embodiment, a GPS-based proximity algorithm may be used to determine that the real estate agent has arrived at the selected property location. Once the real estate agent has arrived, a message may be displayed on the electronic devices of the agent and the user (for example, buyer or renter), asking them both to confirm that they have connected. In at least one embodiment, a GPS-based arrival tracking algorithm may be used to determine if the confirming agent is delayed more than a reasonable period while in route. If so, the user-client device of the user may be configured to display a message such as: “[Agent's Name] is delayed. We found [New Agent], who will arrive in [X] minutes, Please confirm if you want to wait for [New Agent].” Thus, a user may be provided with an opportunity to search for a different real estate agent, should the need arise.

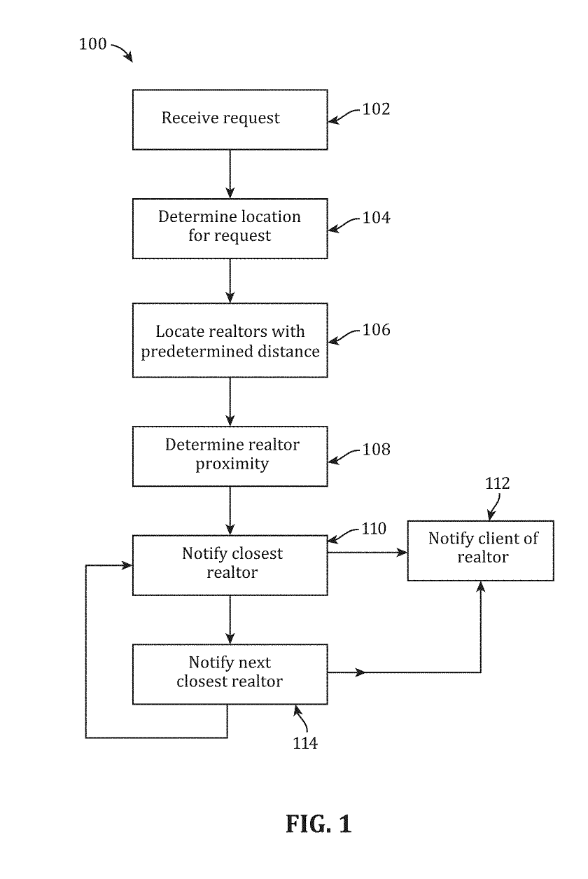

FIG. 1 illustrates a method 100 utilizing the technologies described herein. As illustrated, the method includes several steps. The steps illustrated are for illustration purposes and other steps may be implemented. Additionally, while a particular order is illustrated in FIG. 1, the present technology may be implemented in other arrangements such that the order of the steps may be different than that as illustrated. Furthermore, the present technology may include steps that are not illustrated and other embodiments may be such that one or more of the steps are removed.

The method 100 comprises receiving 102 a request from a buyer or renter of real-estate for a showing at a particular property location. The request may be received from a user client-device associated with the buyer or renter. The method 100 then proceeds to 104, in which the location corresponding to the request is determined. In embodiments, the buyer or renter may enter the location of the property manually, may enter the location of the property using GPS coordinates where the property is located, or may capture an image of the property which may be subsequently analyzed, using one or more algorithms on the user client-device or analyzed on a remote server such as, for example, 10 Minute Realty™ Server so as to determine the location of the property. The method 100 then proceeds to 106 in which real estate agents having a location within a predetermined distance from the location of the buyer or renter or the real-estate property, or having an estimated travel time to the location of the buyer or renter or the real-estate property within a predetermined travel time may be located. Once the relevant real estate agents are located, the method proceeds to 108. At 108, the method 100 may determine the distances of all the real estate agents identified in 106. The method 100 then proceeds to 110, in which the closest real estate agent may be notified of the request. If the real estate agent responds positively to the showing request, the method 100 proceeds to 112, in which the client is notified of the positive response. The method 100 then ends. If the real estate agent does not respond positively, the method proceeds to 114, in which the next nearest real estate agent is notified of the showing request. If the real estate agent responds positively to the showing request, the method 100 proceeds to 112, in which the client is notified of the positive response. That is, the client receives a meeting notification. The method 100 then ends. The method 100 may continue to notify real estate agents until the list of all identified real estate agents is exhausted. In at least one embodiment, if no agent accepts the user's request for a showing within a reasonable period of time, the user may be notified of this fact. The client-user may thereafter be given the opportunity to indicate if she would like an agent to contact them to schedule a showing at a later time. In at least one embodiment, the distance for searching for a real estate agent may be adjusted, either automatically, or by user selection, and the process of searching for a real estate agent in the broader area may continue, if the user desires.

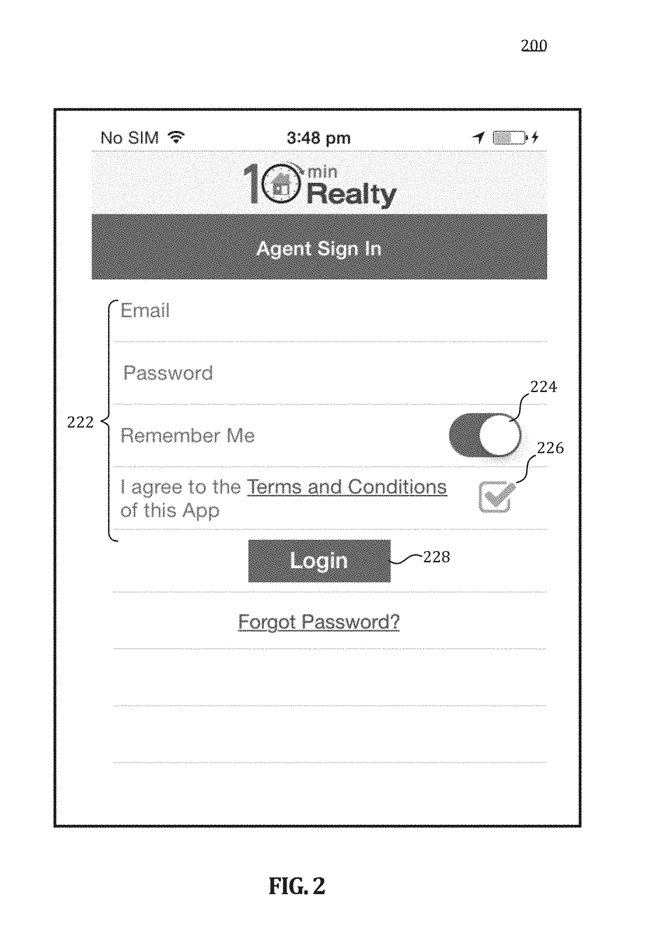

FIG. 2 illustrates an embodiment of an agent login screen 200. The agent login screen 200 may include login input 222 that permits the real estate agent to login. In at least one embodiment, the login input 220 may include several fields such as, for example, email, password, a Remember Me option, and a Terms and Conditions agreement option. The Remember Me option may have a switch 224 where the user (for example a buyer or renter) may input information whether to remain signed in after the application closes. The Terms and Conditions agreement option may have a check box 226 where the user may input whether he or she agrees with the Terms and Conditions. The agent login screen 200 may include a login button 28. If the login input 222 is satisfactory, triggering the login button 228 grants the user access to the application.

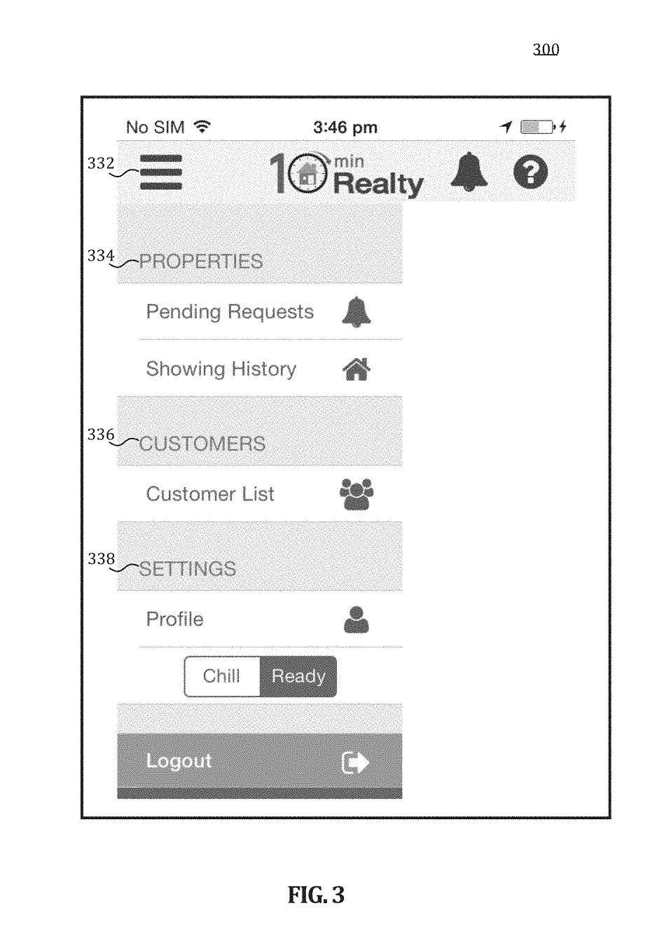

FIG. 3 illustrates an embodiment of an agent application menu 300. The agent or real estate agent may trigger a menu icon 332 to access the agent application menu 300. The agent application menu 300 may include a properties submenu 334, a customer's submenu 336, and a settings submenu 338. In the properties submenu 334, the agent or real estate agent may access information regarding properties. In one embodiment, the properties submenu 334 may include pending requests and showing history. In the customer's submenu 336, the agent or real estate agent may access a customer list. In the settings submenu 338, the agent or real estate agent may access the user real estate agent's profile information.

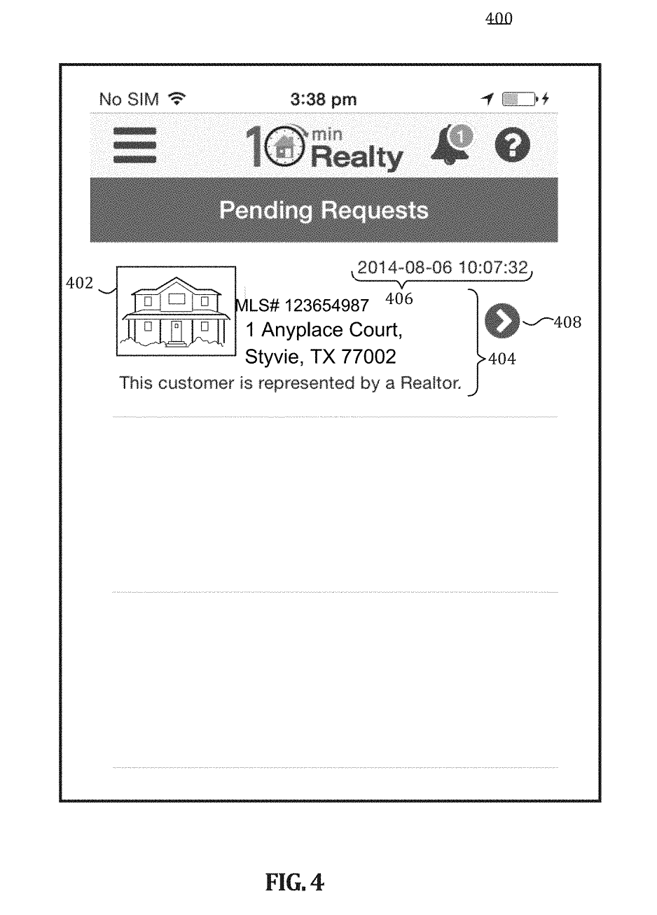

FIG. 4 illustrates an embodiment of an agent pending requests screen 400. The agent pending requests screen 400 may include an image 402 of the property, for example, a house. The agent pending requests screen 400 may include the time and date 406 that the request for an appointment was made. The agent pending requests screen 400 may include property information 404. The property information 404 may include, but is not limited to, the listing number, the address, and whether the customer buyer or renter is represented by a real estate agent. The real estate agent may select the property to access more information by triggering the select button 408.

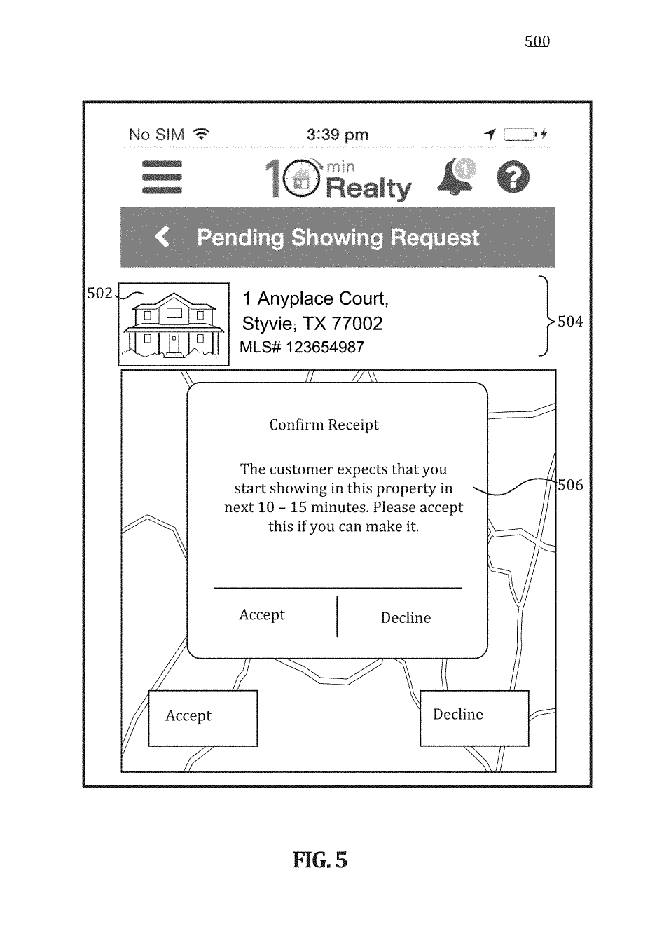

FIG. 5 illustrates an embodiment of an agent request action screen 500. The agent request action screen 500 may include an image 502 of the property. The agent request action screen 500 may include the property information 504, which may include, but is not limited to, the address and listing number of the property. The agent request action screen 500 may display a confirmation screen 506 where the real estate agent may decide to accept or decline the request to show the property.

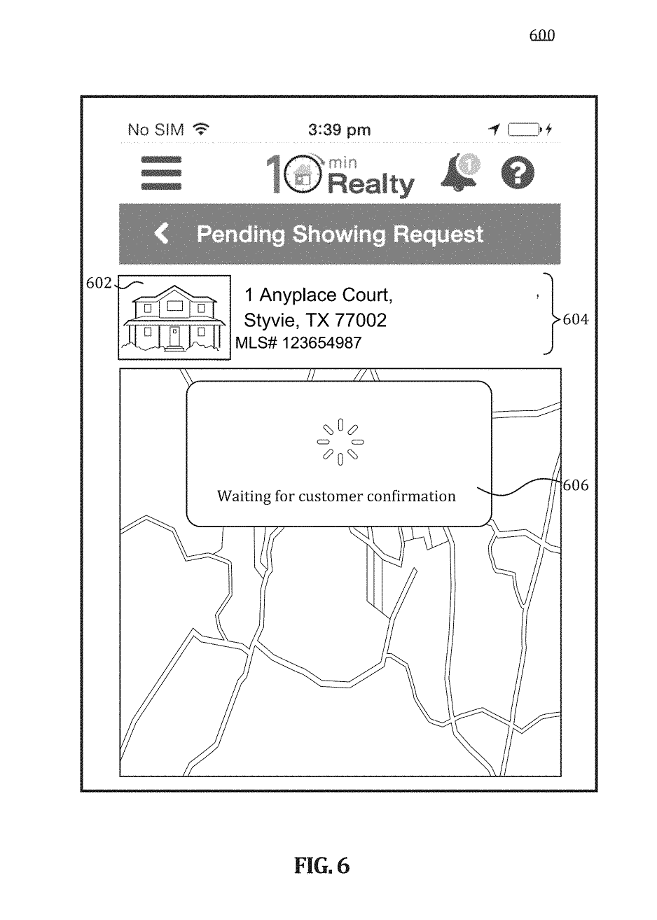

FIG. 6 illustrates an embodiment of a real estate agent customer confirmation screen 600. The customer confirmation screen 600 may include an image 602 of the property. The real estate agent customer confirmation screen 600 may include the property information 604 which may include the address and listing number of the property. When waiting for the real estate agent to confirm the request, an idle screen 606 is displayed.

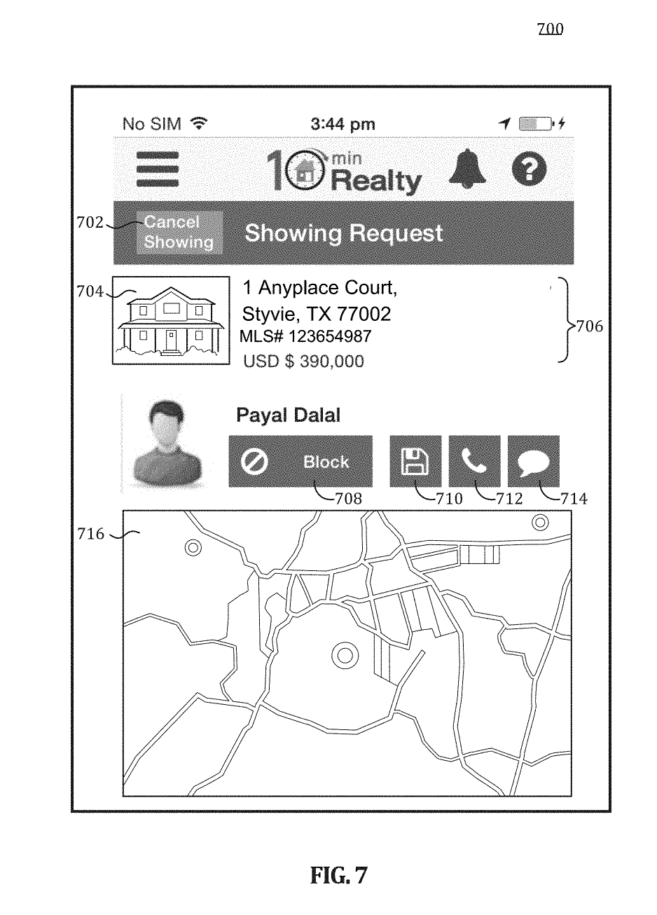

FIG. 7 illustrates an embodiment of an agent active request screen 700. When the real estate agent decides not to show the property, the real estate agent may trigger the cancel showing button 702 to cancel the appointment with the buyer or renter. The agent active request screen 700 may include an image 704 of the property. The agent active request screen 700 may include the property information 706, which may include, but is not limited to, the address, listing number, and listing price of the property. From the agent active request screen 700, the real estate agent may block the buyer or renter by triggering the block button 708. The real estate agent may save the customer information by triggering the save button 710. The real estate agent may call the customer by triggering the call button 712. The real estate agent may message the customer by triggering the message button 714. The agent active request screen 700 may include a map 716 that displays the location of the property.

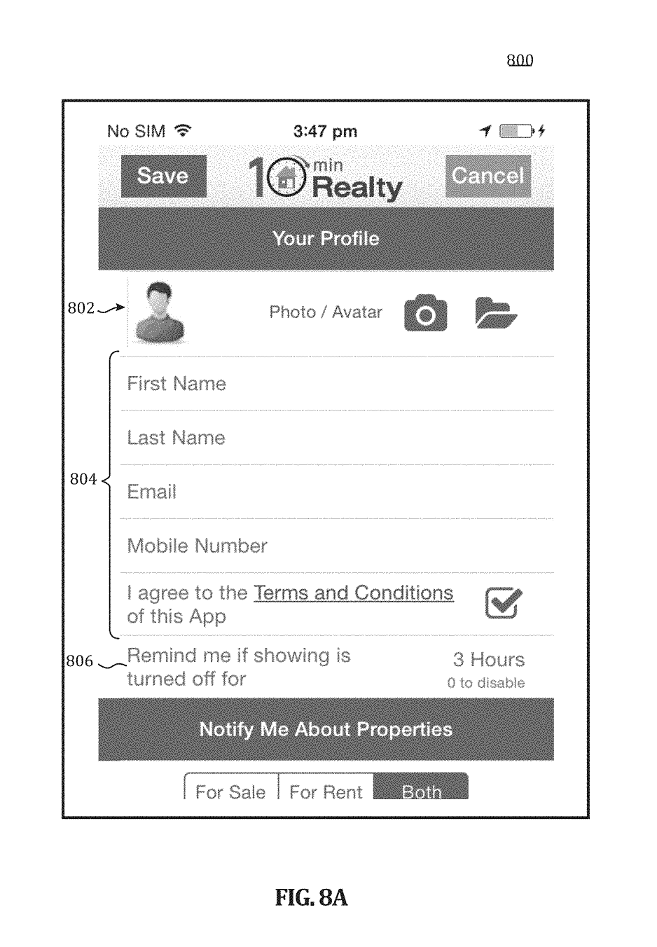

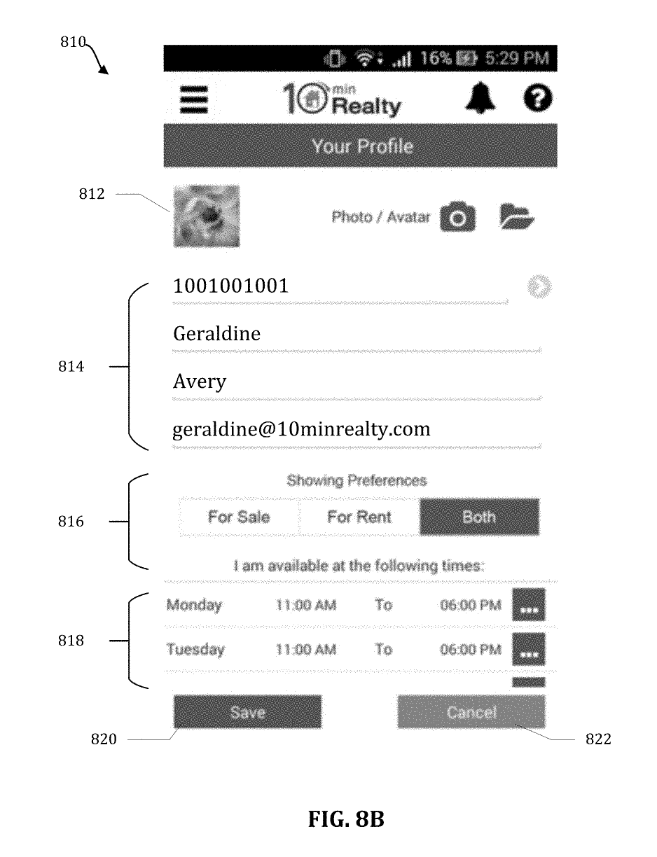

FIG. 8A illustrates an embodiment of an agent Profile screen 800. The agent Profile screen 800 may include agent preferences including an agent Photo/Avatar section 802, an agent personal information section 804, and an agent “Remind Me” section 806. In at least one embodiment, the agent photo or avatar may be changed by triggering the camera icon or folder icon in the agent photo/avatar section 802 of the agent Profile screen 800. In some embodiments agents may store multiple photos or avatars in the folder icon. The Remind Me section 806 allows agents to set a reminder for previously scheduled appointments, wherein the appointment will occur at a predetermined period of time.

FIG. 8B illustrates another embodiment of an agent profile screen 810. The agent profile screen 810 may include agent preference fields including an agent Photo/Avatar section 812, an agent personal information section 814 (for example, real estate agent identification or license information, first name, last name, email address). Agent profile screen 810 may also include preferences that provide showing preferences 816 that include properties that the agent can show and available times 818 that the agent can be available to show a property. In one embodiment, one or more of the agent preference fields including agent photo or avatar, agent personal information section, available times may be changed by amending the information in the particular fields of the agent profile screen 810 and selecting save 820. Alternatively, any selected changes may be canceled by selecting cancel 822.

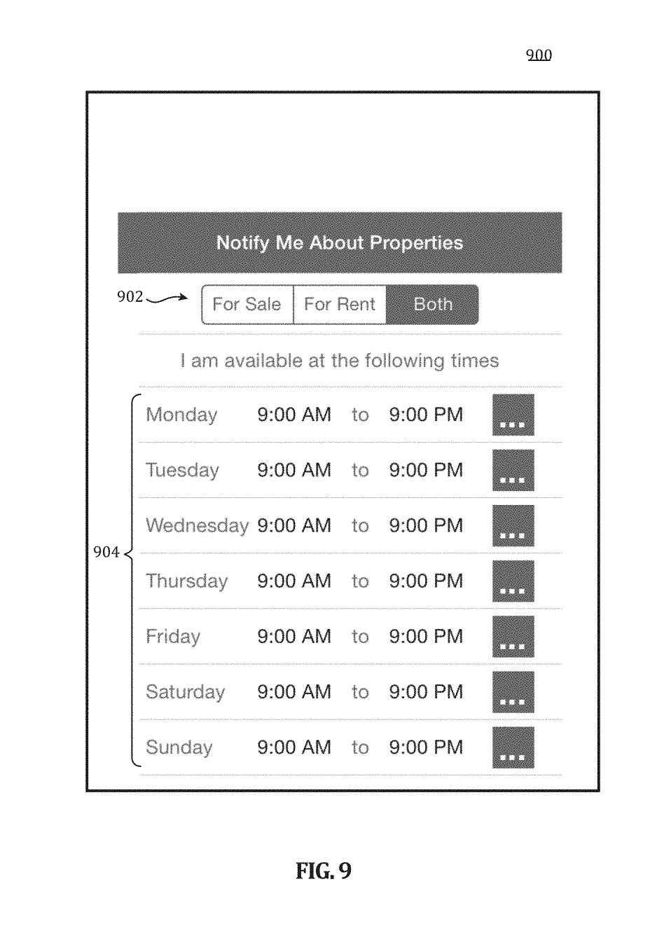

FIG. 9 illustrates an embodiment of an agent settings screen 900. The agent settings screen 900 may include a notification menu 902 and an availability section 904. In at least one embodiment, the notification menu 902 allows agents to have the application notify them when properties become available for sale, for rent, or for both These notifications may be set to notify the agent of different occurrences including, but not limited to, houses that come available for sale, houses that come available for rent, and both houses that come available for sale or for rent. In at least one embodiment, agents may use the agent settings screen 900 to record their availability throughout the week in the availability section 904.

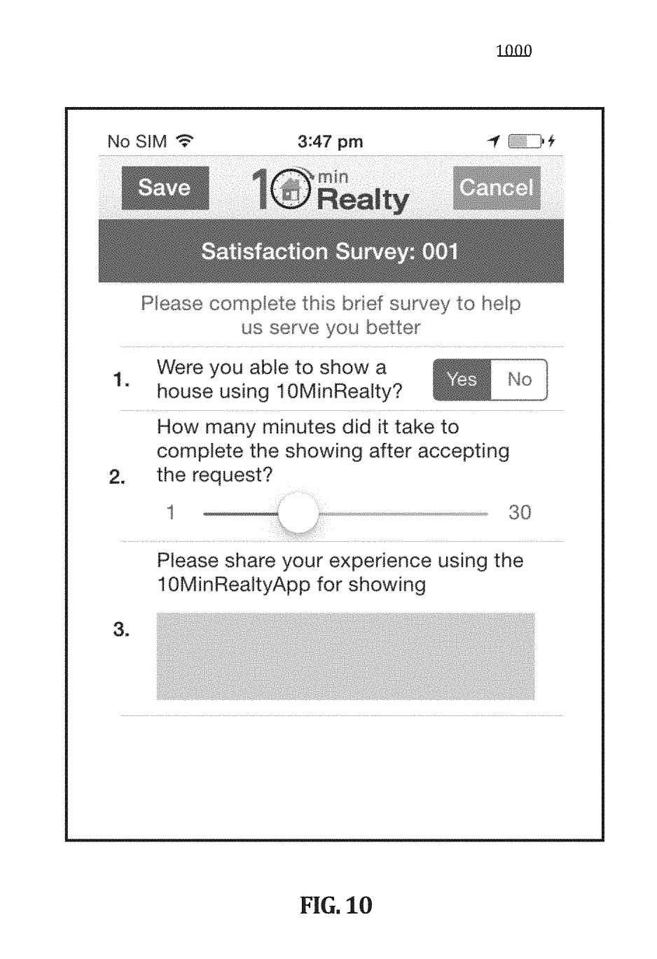

FIG. 10 illustrates an embodiment of an agent feedback screen 1000. In some embodiments, the agent feedback screen 1000 may prompt an agent to respond to a series of questions in order to determine the agent's satisfaction with the application. The questions may cover a variety of topics including, but not limited to, whether or not an agent was able to show a house using the application, how long the showing took to complete after accepting the request from a client, and sharing the experience with other agents.

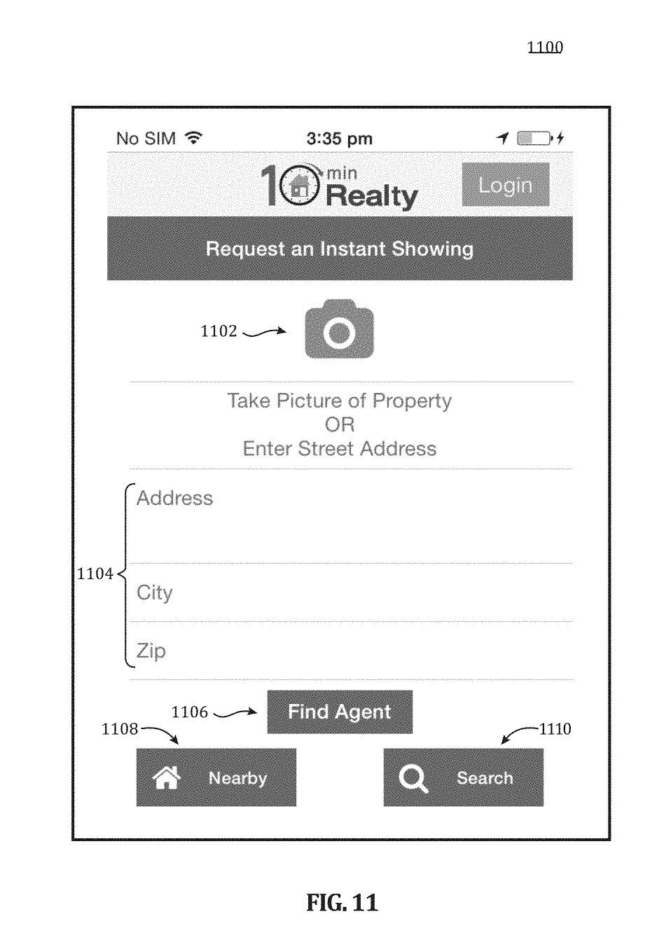

FIG. 11 illustrates an embodiment of a client Instant Showing screen 1100 prior to login. The client Instant Showing screen 1100 may include a camera icon 1102, an address section 1104, a find agent button 1106, a nearby button 1108, and a search button 1110. In some embodiments, when the camera icon 1102 is triggered, the camera on the portable electronic device is triggered, allowing the client to take and upload a photograph of a house they are interested in seeing. The client Instant Showing screen 1100 also provides an address section 1104, wherein a client may enter the address of a house they would like to see. Once the client has either uploaded a photograph or entered a street address, the client may engage the find agent button 1106 to trigger the Application to find a real estate agent that is able to show the client the house. The client may expand their viewing to nearby houses by selecting the nearby button 1108, triggering the application to produce a series of houses for rent or purchase nearby the entered location. A client may begin a new search by triggering the search button 1110.

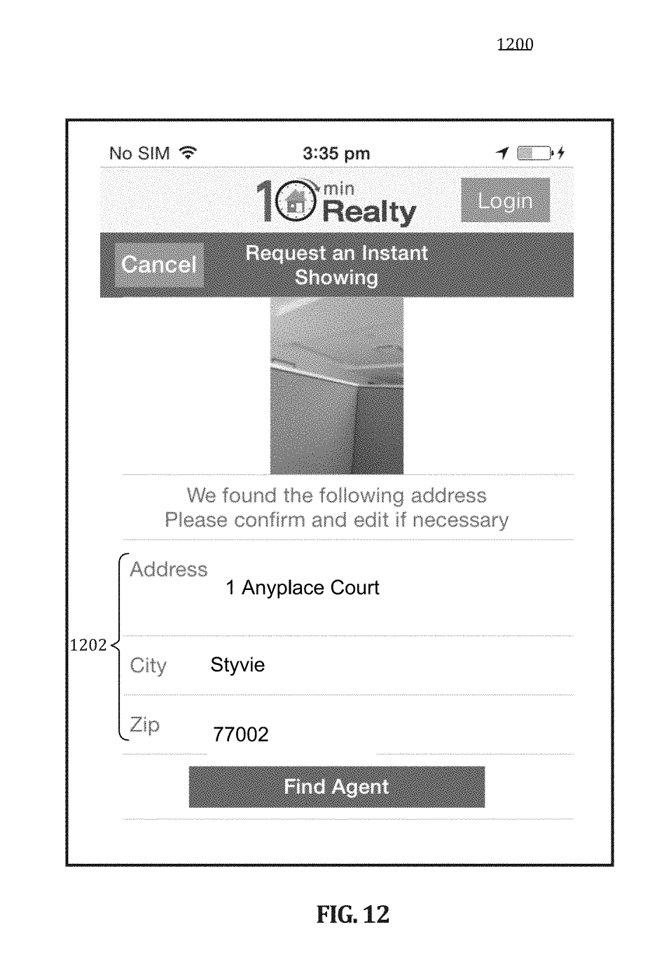

FIG. 12 illustrates a reverse geocoding screen 1200 before login. The reverse geocoding screen 1200 may include an address confirmation section 1202. In at least one embodiment, once a client has uploaded a photograph of a house they would like to view, the application will locate the house using a GPS system, retrieving GPS information/data regarding the located house/property. Once the application has located an address for the house, the address will be displayed in the address confirmation section 1202 of the screen for confirmation by the client that the location is accurate.

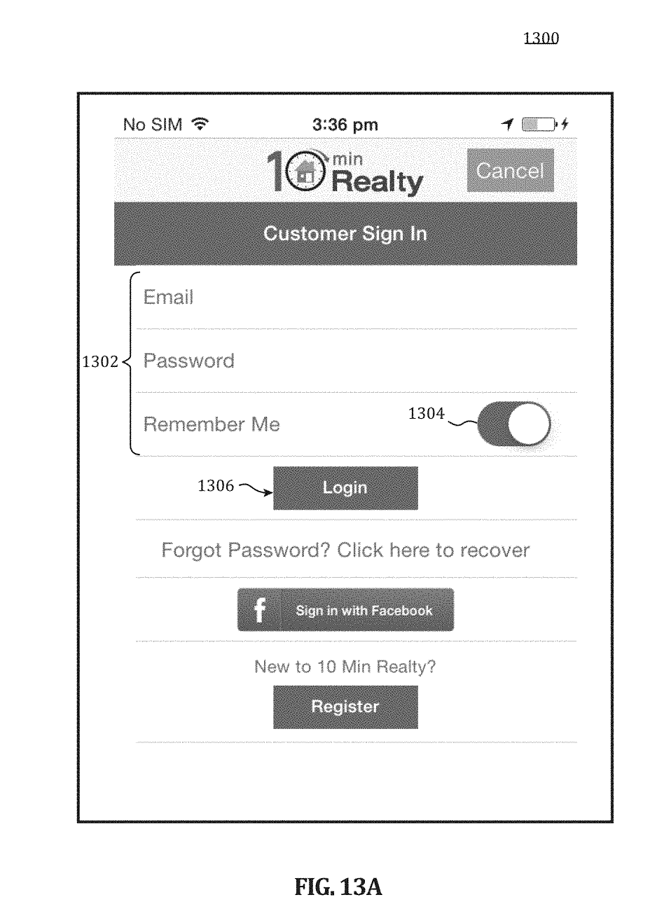

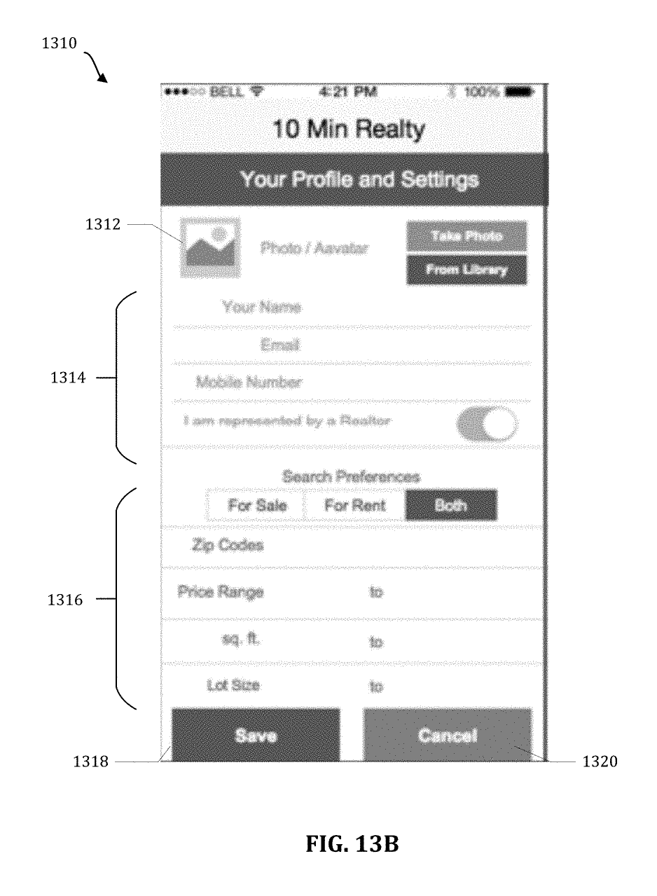

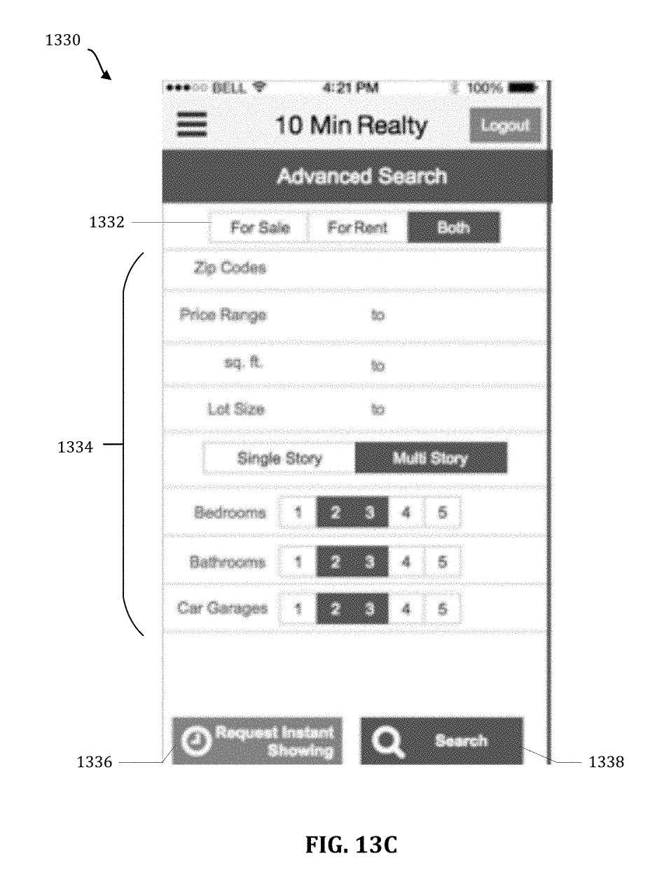

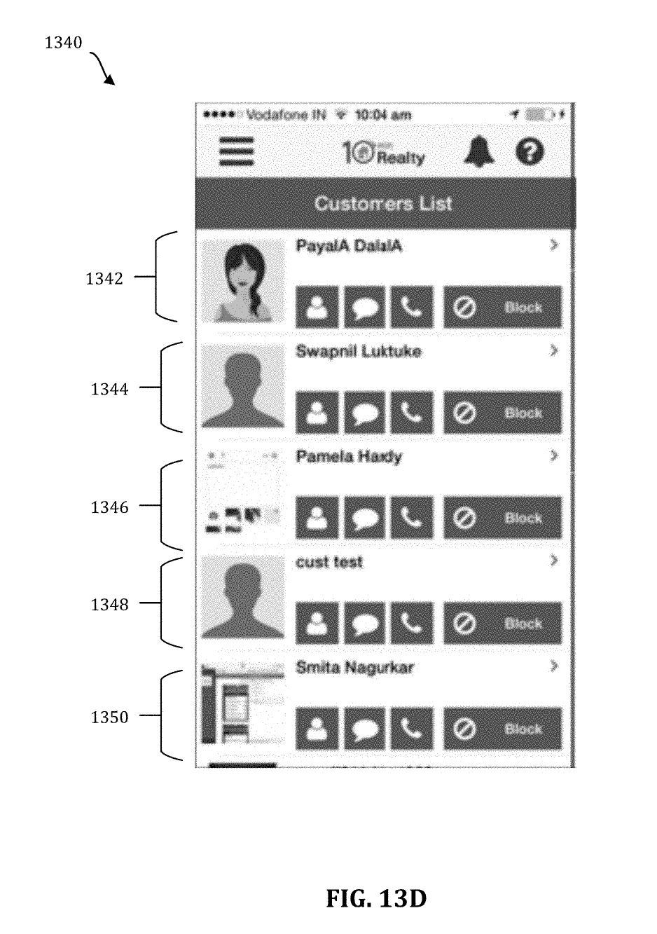

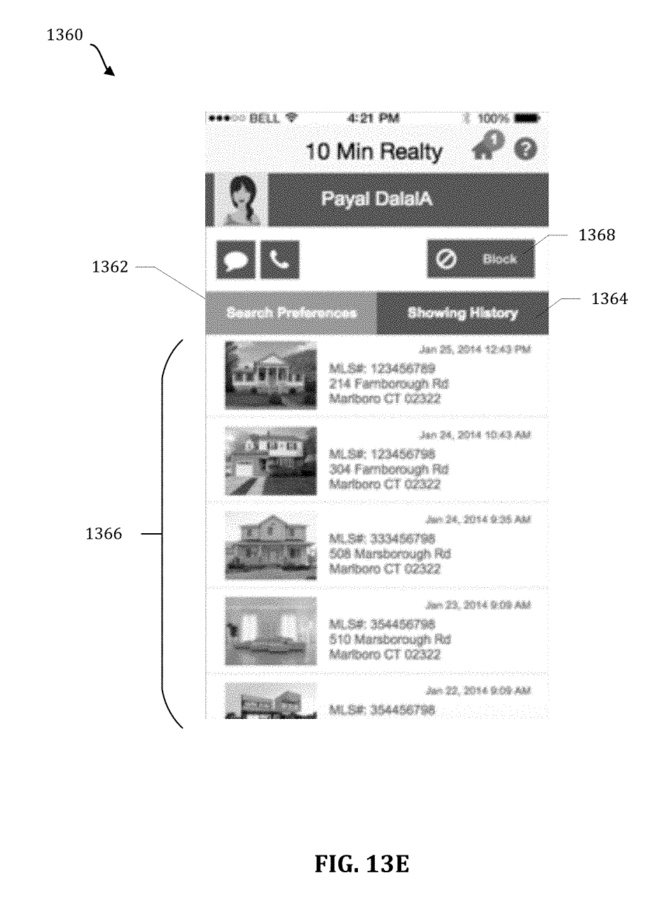

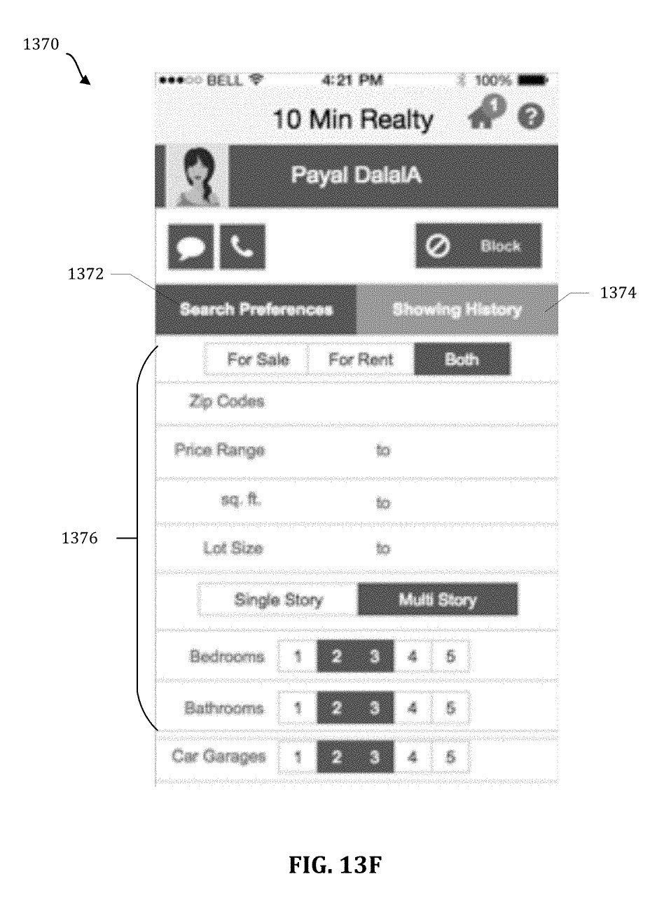

FIG. 13A illustrates an embodiment of a customer login screen 1300. The customer login screen 1300 for a user may be associated with a buyer or renter account and can include a login section 1302, a “remember me” option, and a login button 1306. In at least one embodiment, the login section 1302 allows a customer to login to a profile using a previously saved email address and password. The remember me option may have a switch 1304 that may be triggered by the user to remain logged into their profile after the application is closed. The customer may complete the login process by selecting the login button 1306 triggering the application to verify the customer information.

FIG. 13B illustrates an embodiment of a customer profile screen 1310. The customer profile screen 1310 for a user may be associated with a buyer or renter account to create preferences as to the real-estate property that the user may be interested in viewing. The customer profile screen 1310 may include a user Photo/Avatar section 1312, a user personal information section 1314 (for example, buyer or renter name, email address, cell phone number, and whether the buyer or renter is represented by a real estate agent). Customer profile screen 1310 may be accessed after the user accesses the user account using customer login screen 1300 as shown and described in FIG. 13A. The customer profile screen 1310 may also include property preference section 1316 including homes sizes, rent or buy, price range, square foot size, or the like.

FIG. 13C illustrates an embodiment of an advanced search screen 1330. The advanced search screen 1330 for a user associated with a buyer or renter account may be used within the customer login screen 1300 of FIG. 13A for entering additional preferences for the user, which may be saved to the user's profile. Preferences can include sale or rent 1332, property size and location preferences 1334, which may be transmitted to a real estate application for viewing using showing button 1336. The information may be populated in a real estate agent application once the realtor accepts a showing request from a buyer or renter as shown in FIGS. 13D-13F. Alternatively, the user may search for properties using the search button 1338

As shown in FIGS. 13D-13F, a real estate agent account may include a list of buyer or renter accounts including user preferences that are received within a real estate agent application. As shown in FIG. 13D, a customer list screen 1340 can include a list of user contact information 1342-1350 for each particular user. As shown in FIG. 13E, a customer details screen 1360 for viewing by a real estate agent can include detailed information tabs regarding a particular user's search preferences 1362 and showing history 1364. For example, a real estate agent, within the real estate agent application may select a particular user, for example, user 1342 (FIG. 13D) and view the user's showing history for a particular time period. Also, in an embodiment, a realtor may block a user from contacting the realtor by selection of block button 1368. As shown in FIG. 13F, a customer details screen 1370 can include detailed information tabs regarding a particular user's search preferences 1372 and showing history 1374. For example, a real estate agent, within the real estate agent application may select a particular user, for example, user 1342 (FIG. 13D) and view the user's showing history for a particular time period as well as the user's property preference 1376 in home sizes and location (sale, rent, both sale and rent, zip code, price range, lot size, home size, or the like).

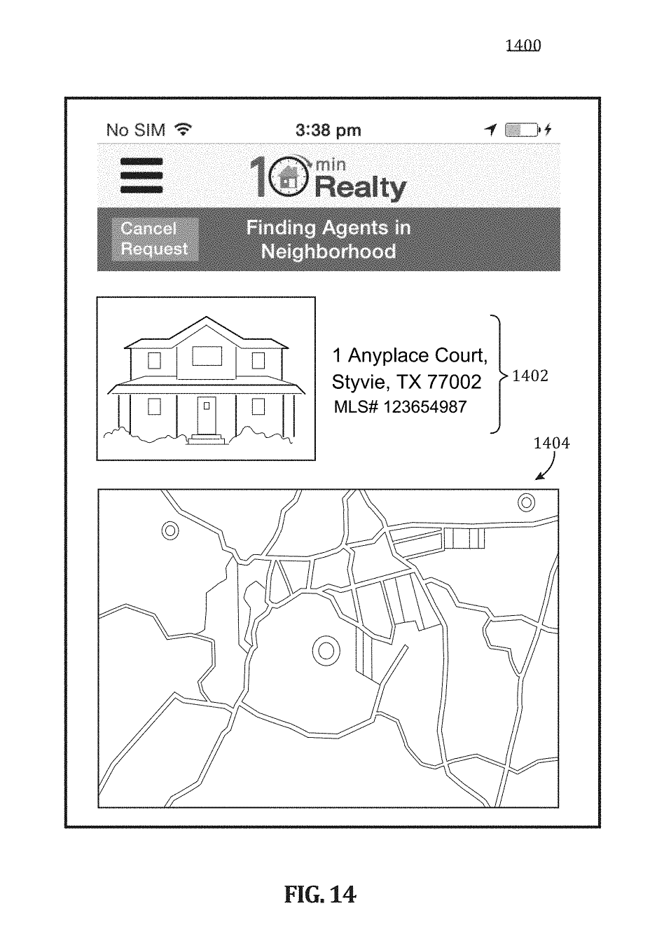

FIG. 14 illustrates an embodiment of a screen for finding a real estate agent in a neighborhood. The address of the prospective property 1402 may be displayed on a top portion of the dashboard. The top portion of the dashboard may also include a picture of the property. The dashboard may also include a map 1404 showing the user's current location and orientation. The map may further include prospective real estate agents' locations.

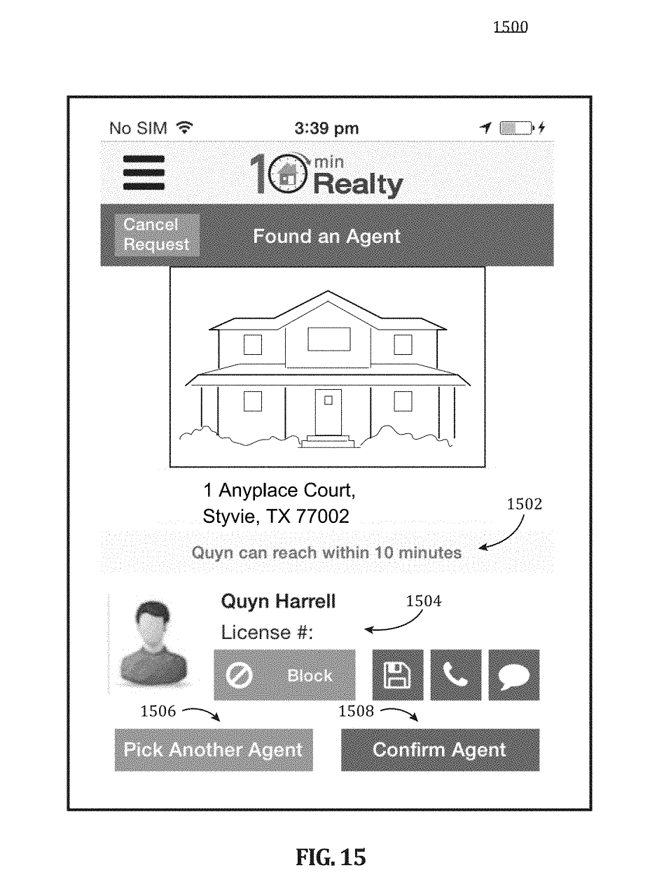

FIG. 15 illustrates an active request screen 1500 for a showing. The screen 1500 may display an estimated time 1502 (a/k/a time estimate) for an identified real estate agent to reach the prospective property. The screen 1500 may further display the requested real estate agent's information 1504 including, but not limited to, name and license number. The real estate agent's information 1504 may also include a plurality of buttons configured to call the real estate agent, text the real estate agent, save the real estate agent, and block the real estate agent. The found real estate agent screen 1500 may further include a button configured to pick another real estate agent 1506 and a button configured to confirm real estate agent 1508. In at least one embodiment, the text the real estate agent button may be configured to operate a chat window, send a text message, or send an e-mail. The screen 1500 may further provide a button configured to message the requested real estate agent.

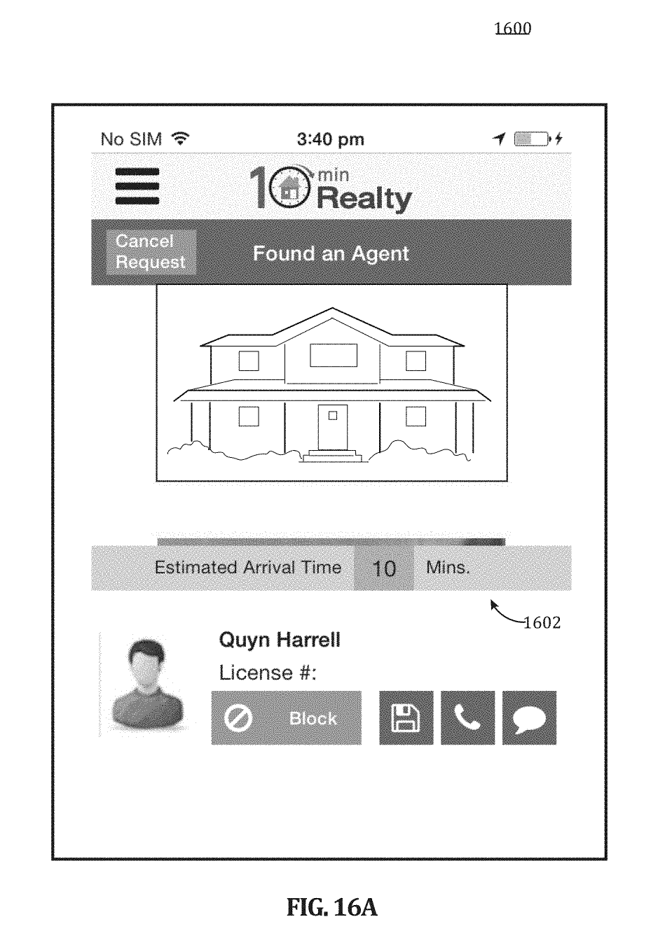

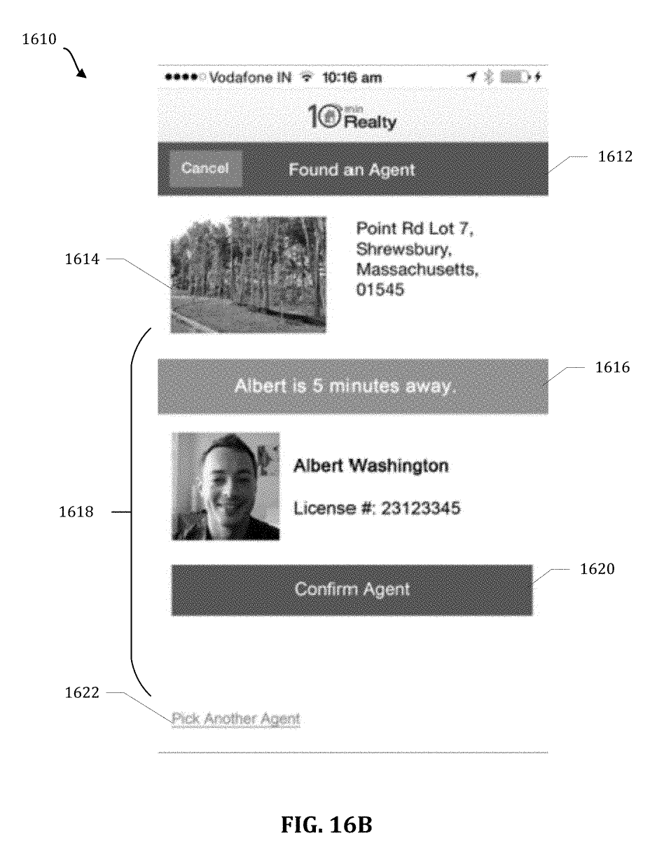

FIG. 16A illustrates an embodiment of a confirmed found real estate agent screen 1600. The screen 1600 may display the estimated arrival time 1602 in minutes. The screen 1600 may also display the confirmed real estate agent's information including, but not limited to, name and license number. The real estate agent's information may also include a plurality of buttons configured to call the real estate agent, text the real estate agent, and save the real estate agent. In at least one embodiment, the text the real estate agent button may be configured to operate a chat window, send a text message, or send an e-mail.

FIG. 16B illustrates an embodiment of a confirmed found realtor screen 1610. The screen 1610 may display caption text 1612 that lets the user buyer or renter know that an agent has been found, property information 1614 for the property address or location and realtor information 1618 associated with the estimated arrival time 1602 in minutes. The screen 1600 may also display realtor information 1618 including displaying the estimated arrival time 1616 in minutes. Realtor information 1618 may also include one or more additional buttons or links configured for, in some example, confirming agent 1620 that authorizes the agent to proceed to meet the user or cancel agent as a cancellation link 1622.

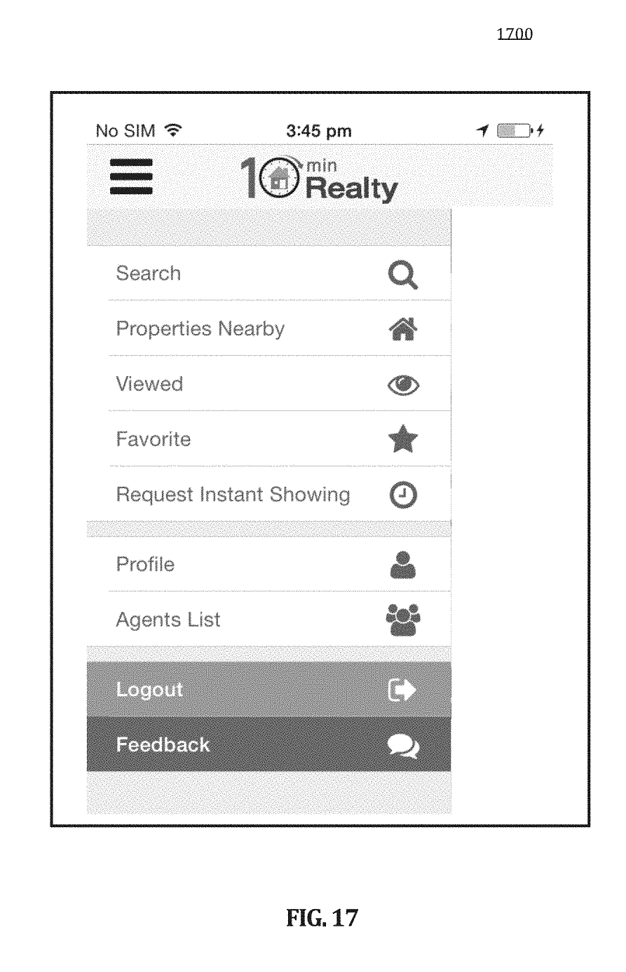

FIG. 17 illustrates an embodiment of a menu screen 1700. The menu screen 1700 may display a plurality of options including, but not limited to, search, properties nearby, viewed, favorite, request an instant showing, profile, agents list, logout and feedback. The search option may allow a user to search properties. The properties nearby may allow a user such as a buyer or renter to view properties within a predetermined range from their current location. The viewed option may show a user the properties previously viewed. The favorite option may show a user properties previously selected as favorite. Request an instant showing may allow a user to request a showing of a specific property. The profile option may show a user their profile including their respective information. The agents list may provide a user with a list of real estate agents. The logout option may allow a user to logout of the application. The feedback option may allow a user to provide feedback and rate their experience.

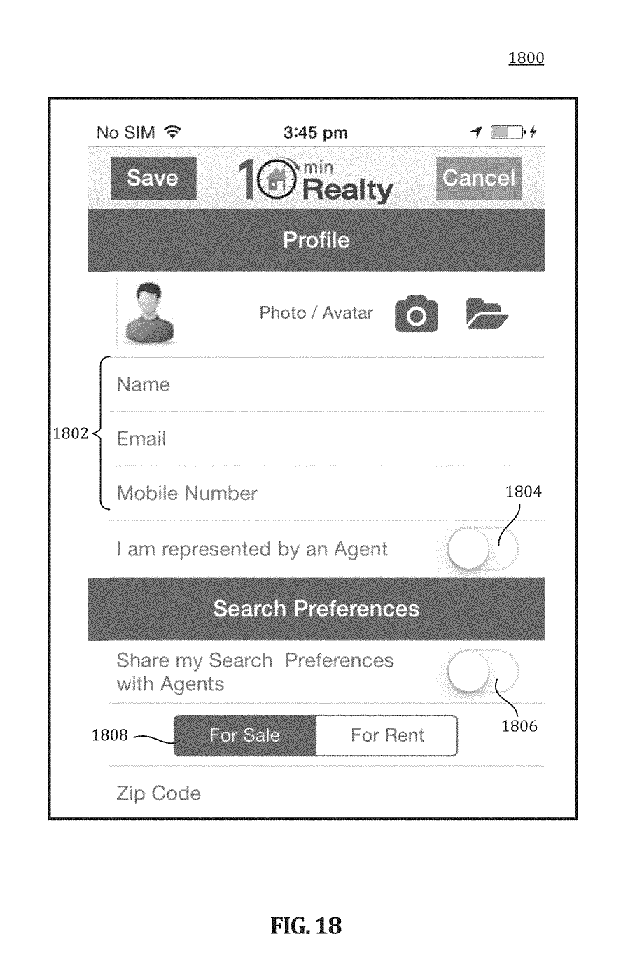

FIG. 18 illustrates a profile screen 1800 showing a user's profile for a user. The profile may include a user's information 1802 including, but not limited to, photograph, name, e-mail, phone number, and whether the user currently has a real estate agent. The profile screen 1800 may also include ability to share or restrict 1806 a user's search preferences from an agent, along with search preferences 1808. Search preferences 1808 may include whether a user is looking for properties for rent or for sale.

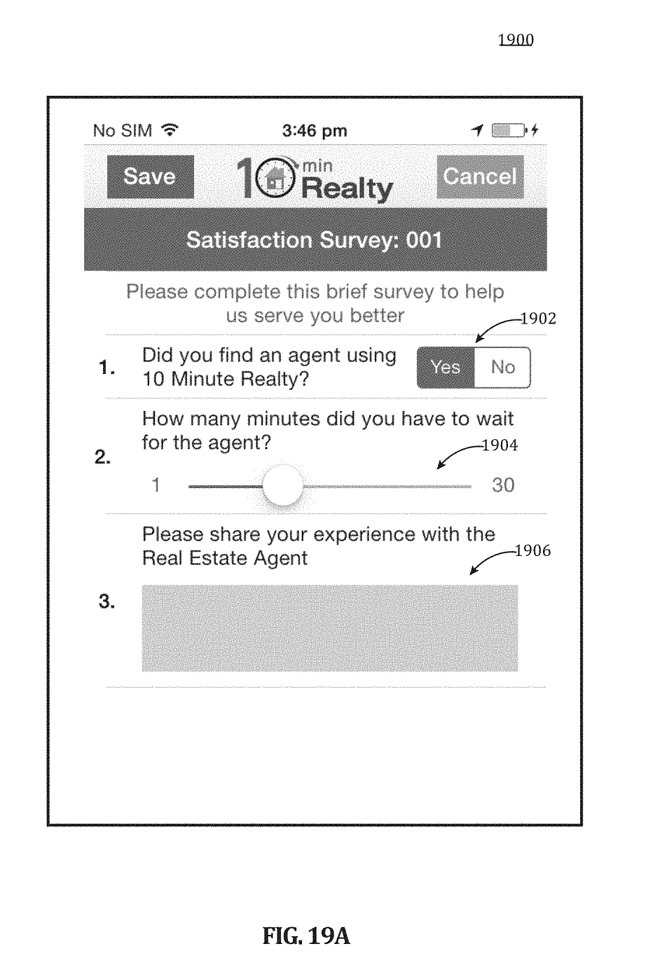

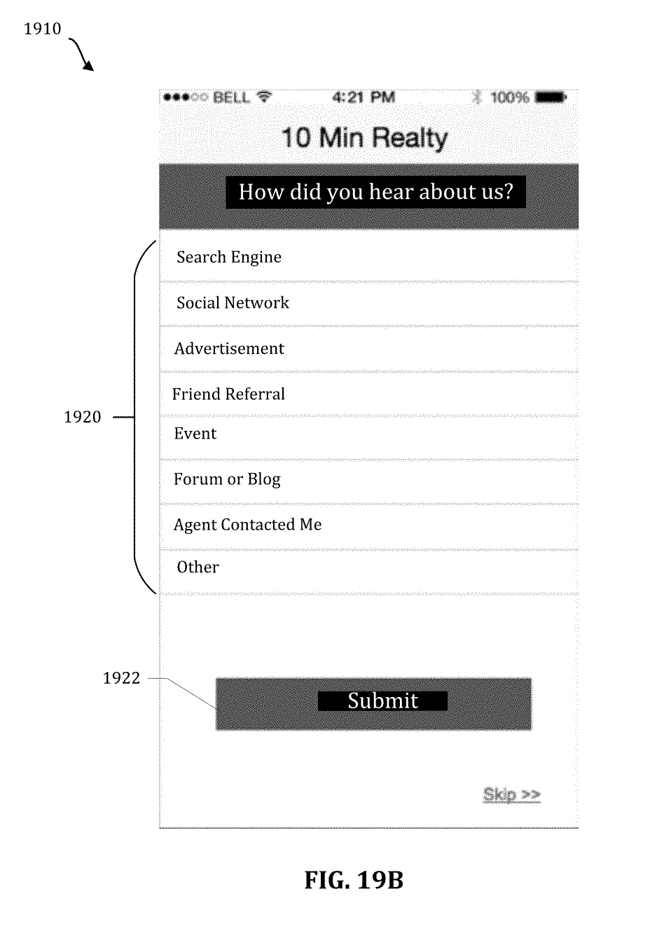

FIG. 19A illustrates a feedback screen 1900 that may be used by a user buyer or renter. Feedback screen 1900 may include information as to whether a the user was able find an real estate agent 1902 using the 10 Minute Realty application and 10 Minute Realty Server, the user's wait time 1904, and user's experience 1906. In at least one embodiment, the feedback screen 1900 may include additional questions, or have fewer questions.

FIG. 19B illustrates another embodiment of a customer feedback screen 1910. The customer feedback screen 1910 may include a plurality of selection choices 1920 that may be accessed within a user's account. For example, the selection choices can include: a search engine a real estate agent, a buyer or a renter through their respective user accounts for selection by a buyer, renter or real estate agent by receiving feedback from the. The selection choices 1720 may be selected and transmitted over a network using the submit button 1722.

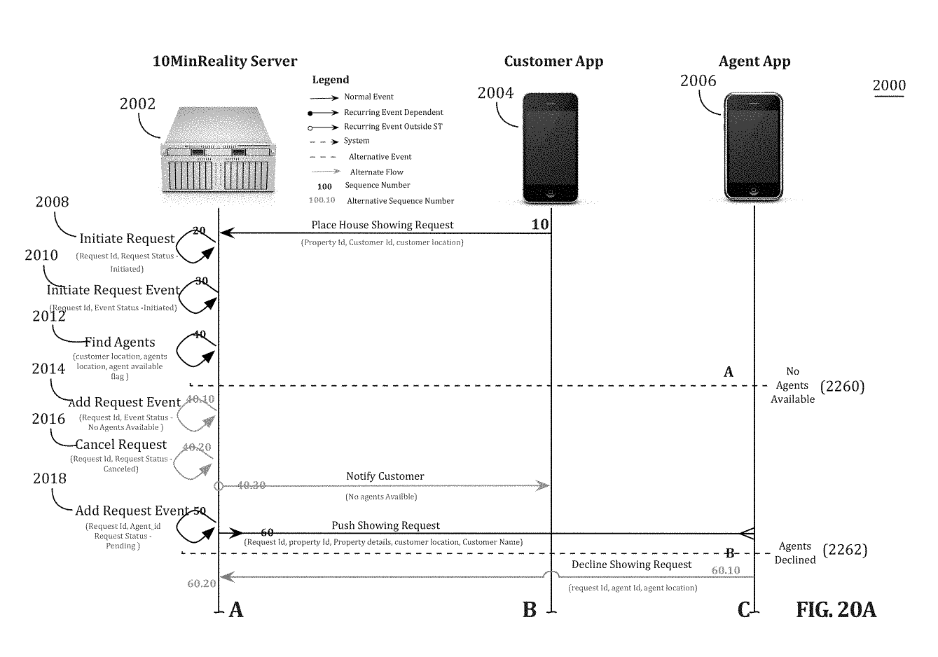

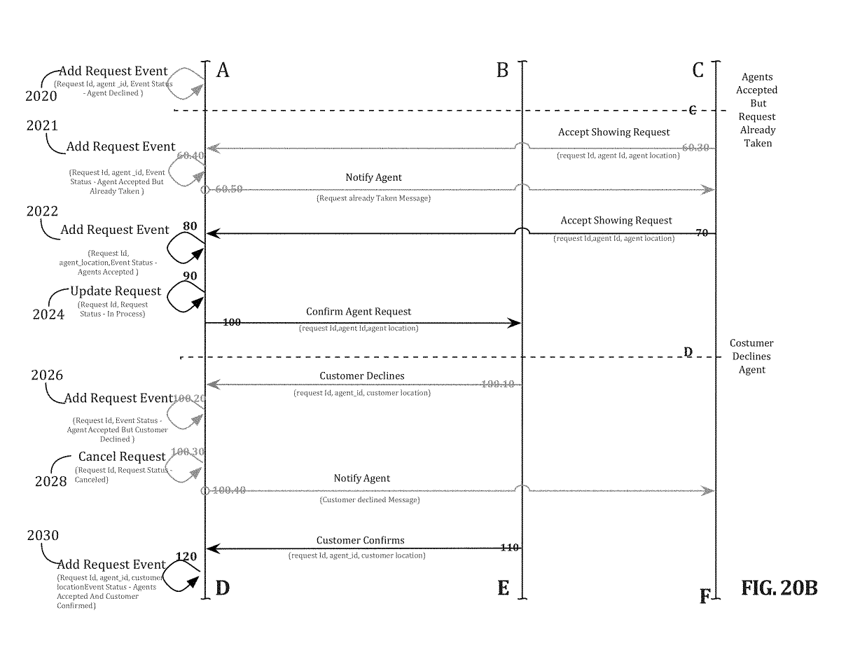

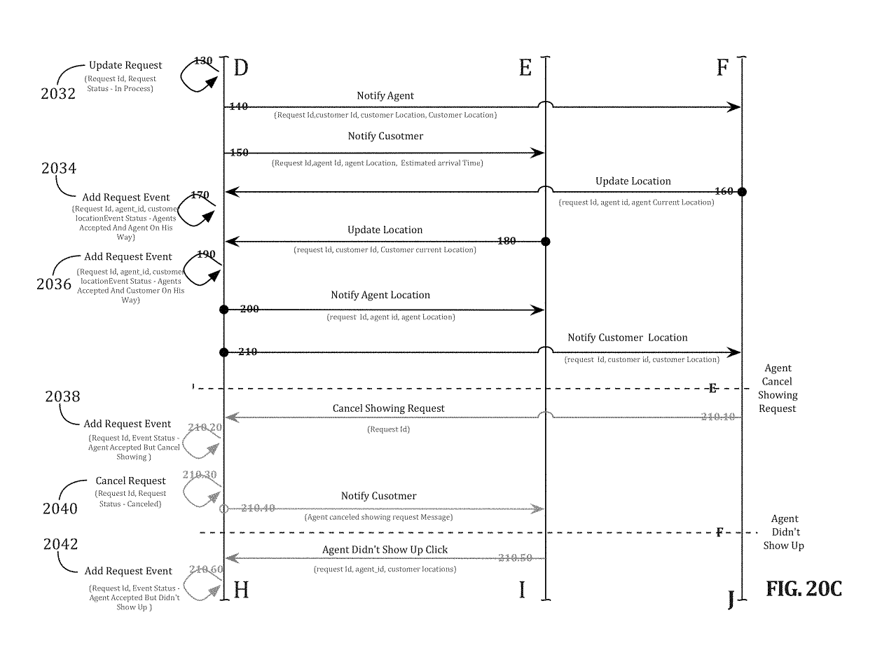

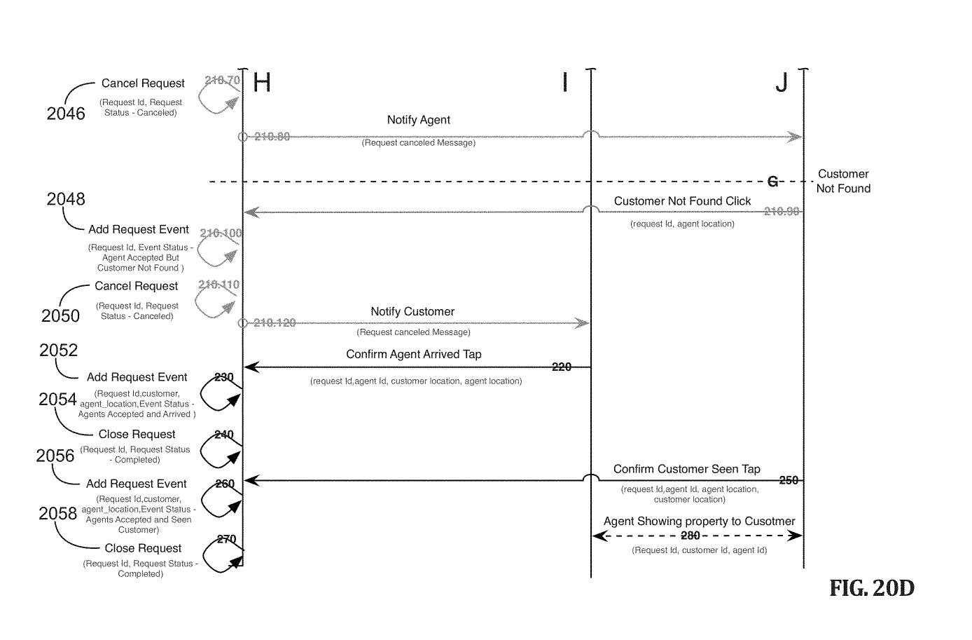

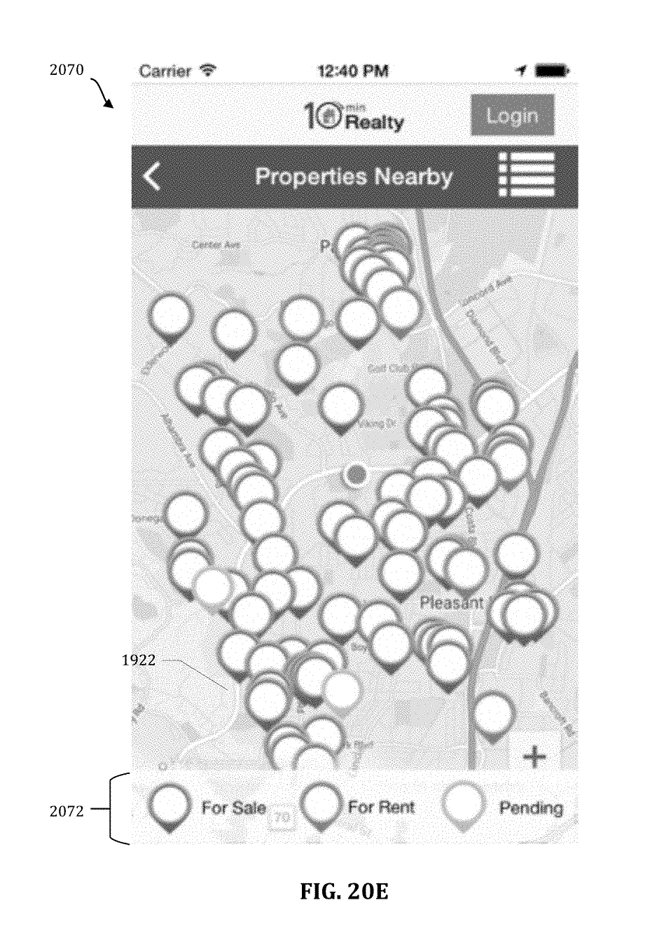

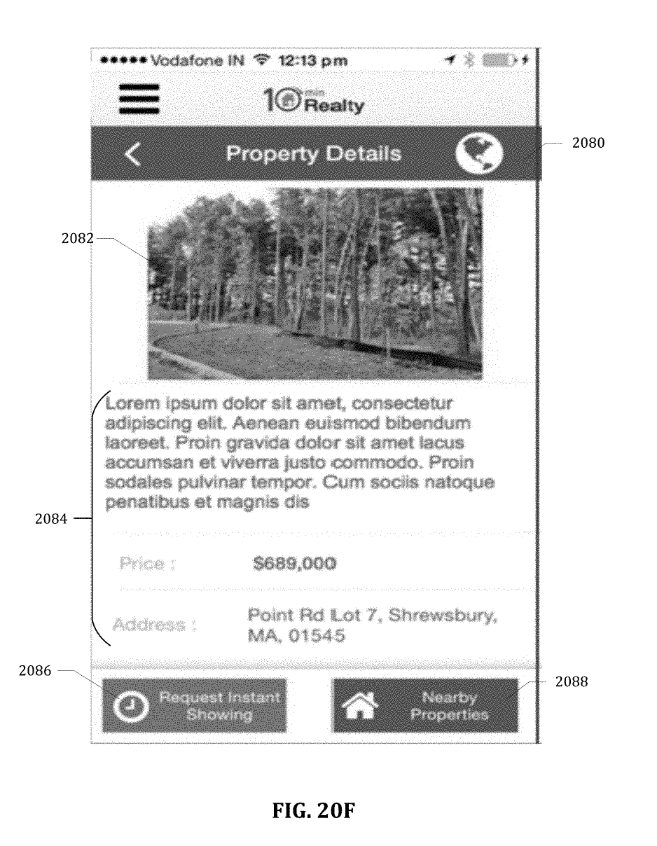

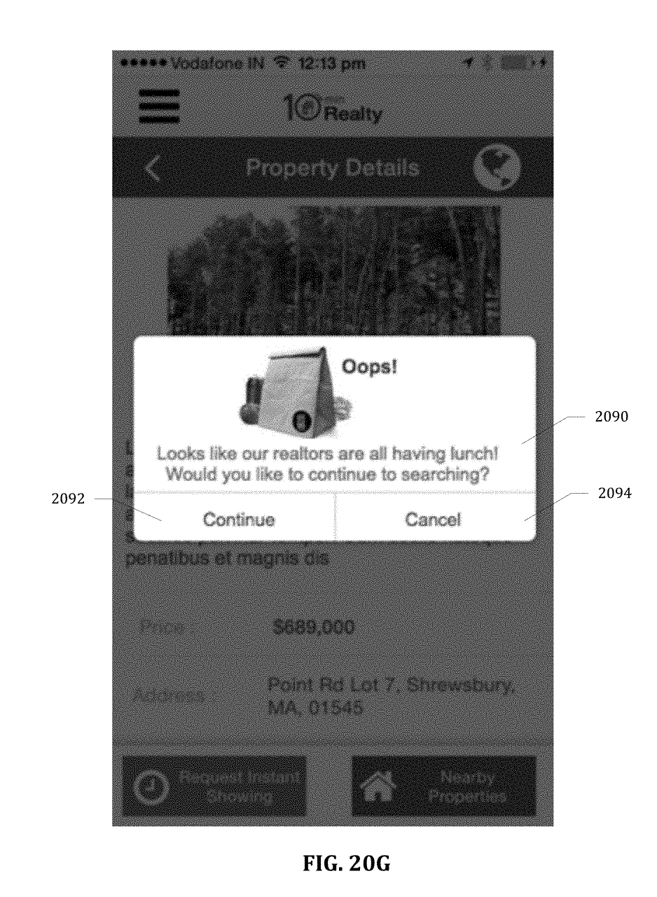

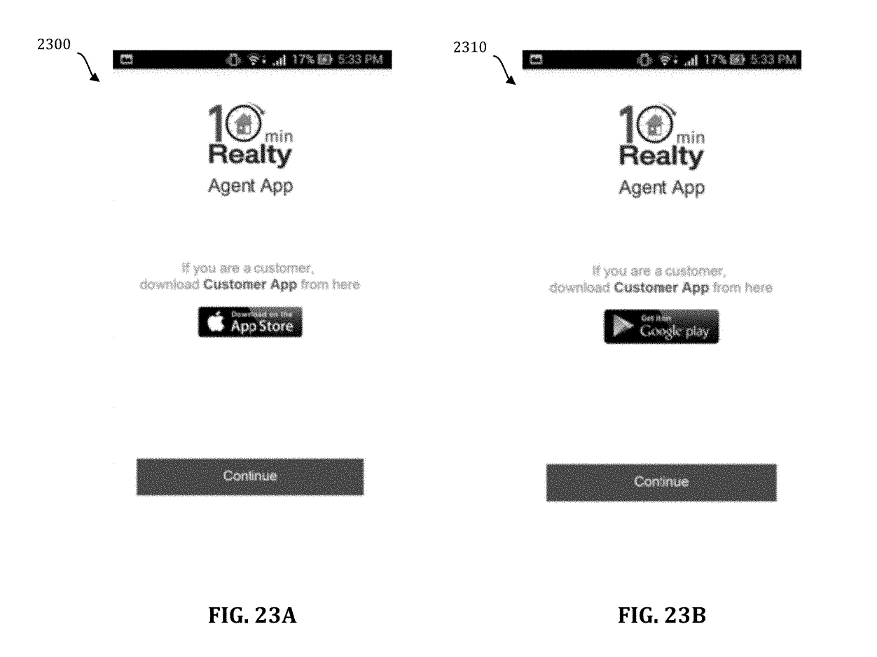

FIGS. 20A-20D collectively illustrate an activity or sequence diagram for implementing a method according to embodiments. The sequence 2000 for a software application may be a plurality of events communicated between a server 2002, a customer application 2004, and a real estate agent application 2006. The customer application 2004 may be a 10 Minute Realty Application that includes preferences designed for a renter while real estate agent application 2006 may be a 10 Minute Realty Application with preferences designed for a real estate agent, as is shown and described with reference to FIGS. 23A-23B. specifically, FIGS. 23A and 23B depict web application landing pages associated with respective Apple and Android applications for 10 Minute Realty. Specifically, FIG. 23A depicts a landing page 2300 for a 10 Minute Realty Application for a real estate agent (for example, agent application) that may be digitally distributed from the Apple Store for a mobile device running a iOS operating system, for example, Also, FIG. 23B depicts a landing page 2310 for a 10 Minute Realty Application for a real estate agent that may be digitally distributed from GooglePlay™ for a mobile device running an Android™ OS operating system from Google™. (Apple Store™ is a service of Apple Inc. and GooglePlay™ is a service of Google, Inc.)

Returning to FIGS. 20A-20D, the server 2002 may be configured to maintain all user information, request data, and provide basic functions such as registration, login information, analytics, configuration, and settings. The server 2002 may also maintain a record of all user's device details and location information. The server 2002 may be configured to communicate with the customer application 2004 and the agent application 2006 using push notifications. In at least one embodiment, the server 2002 may communicate with Apple's™ Push Notification or Google's™ Cloud Message service. (Apple is a registered trademark of Apple, Inc. and Google is a registered trademark of Google, Inc.).

The customer application 2004 may be an application running on a customer's electronic device. The electronic device may be a phone, tablet, laptop, or other electronic device configured to operate the application. In at least one embodiment, the customer application 2004 may be an iOS or Android™ mobile application. The user may download and install the application and register using their mobile number. The customer application 2004 may allow users to register and login without visiting a separate web portal.

The agent application 2006 may be an application running on a customer's electronic device. The electronic device may be a phone, tablet, laptop, or other electronic device configured to operate the application. In at least one embodiment, the customer application 2004 may be an iOS or Android™ mobile application. In at least one embodiment, the website is used by agents for registration and verification of their mobile number and electronic device. The agent may then download the agent application 2006 and login. The agent application may track and periodically update the server 2002 with the agent's location, when properly authorized. In at least one embodiment, the server 2002 may send push notifications about nearby showings and make periodic web service calls to the server 2002 to get the latest information in the event push notifications are not working.

While the sequence below may be described with reference to a transaction between a buyer and a real estate agent, for ease of understanding, the sequence 2000 may also be applicable to a transaction between a renter and real estate agent without limiting the scope of the invention. The sequence 2000 may begin with a buyer initiating an event 2008 for a showing request for a property from the customer application 2004. The buyer may search for the property on the customer application 2004 from available active listings. All such listings being stored in one or more databases of listings. In embodiments, the customer buyer may either input the address information for the property, authorize the customer application 2004 to access the GPS location of the user buyer's electronic device, or take a picture of the property, which may be used by the customer application to access active listings by real estate agents and provide these for viewing by the buyer on the electronic device running the customer application 2004. At event 2010, the server 2002 may then validate the property location and generate a showing request. In an embodiment, the buyer may use the customer application 2004 to search for active listings of properties within a geographical location, and the results may be displayed on an interactive map, as is shown in FIG. 20E. Each teardrop on the map 2070 may be associated with a property including their descriptor information 2072. Selecting a property (shown in FIG. 20F) may provide additional property information 2080 for the property. Information 2080 can include an image 2082 of the property. The property may be a house or other property the customer buyer is interested in, detailed information 2084 on the property (e.g., price, address, or the like). Additional buttons or links can include contacting agents to view the property via a request showing 2086 or additional properties near the location using nearby properties button 2088. The sequence 2000 may then proceed to event 2012 to find agents using, for example, request showing button 2086 (FIG. 20F). Event 2012 may be based on customer buyer location, agent location, and agent availability. In at least one embodiment, the system can information regarding retrieve real-estate properties which are similar to the real-estate property in question. Similarity being defined according to predetermined and/or user-selectable criteria. Such criteria can include, but are not limited to, proximity to a school building, asking price, square-footage, number of floors, neighborhood location.

If no agents are available, event 2014 may notify the buyer that no agents are available. The notification may be a push notification. For example, as shown in FIG. 20G, a notification screen can provide a text display 2090 informing the user that no agents are available and the user may continue searching 2092 for properties or cancel 2094 searching for properties. The buyer may then choose to cancel the request, event 2016. If an agent is available, the server 2002 may determine a batch of available agents based on their respective locations relative to the property location and send a push notification with the showing request details. The server 2002 may maintain a list of agents to whom the request is sent. The server 2002 may wait for any of the agents to accept the request for a predetermined amount of time. If no agent accepts, the server 2002 generates a new batch of next closest agents and sends them a push notification with the showing request details. This process continues until either an agent accepts, all agents within a maximum search radius are contacted, or the request times out and no agents respond. FIG. 20F illustrates a screen of an available agent that may be received by the buyer as well as information regarding the location of the agent. The maximum search radius, number of agents in a batch, and time out interval are determined and configuration settings on the server 2002. If no agents accept, the buyer is notified of the unavailability of agents using a push notification, event 2014.

The first agent to accept the showing request is sent to the buyer, event 2020. Event 2020 may alternatively indicate the agent declines the showing request. If a second agent accepts, the second agent is notified of the unavailability of the request because another agent has already accepted (event 2021). If the agent accepts, event 2022 a notification may be sent to the buyer informing about the agent's acceptance along with basic information about the agent. This information may include agent's name, contact details, and profile picture. In at least one embodiment, the agent basic information also includes a video introduction of the real estate agent to the client. In at least one embodiment, the buyer may upload an introduction video introducing buyer to real estate agent. The buyer may choose to video in front of the property to be shown. The introduction videos (both agent and buyer) may be transmitted within the application, via email, text message, or other available method. In at least one embodiment, the client can receive multiple acceptances of the showing request, and the system will determine which acceptance from amongst the plurality of acceptances should be transmitted to the electronic device of the buyer.

After notification, the sequence 2000 may proceed to event 2024, in which the customer is prompted by the customer application 2004 to confirm the agent or reject and opt to find another agent for the same property. The buyer may decline the agent, event 2026, or the buyer may cancel the request, event 2028. If the buyer opts to find another agent, the agent is notified and a new showing request with the same buyer and property information is initiated. The rejected agent is not included while searching for agents with this new request. Optionally, the sequence 2000 may return to 2010 to initiate a new showing request.

Alternatively, the buyer may confirm the agent, event 2030. If the buyer accepts the agent, event 2032 notifies the agent. Following notification, an event 2034 indicates the agent is on his way to the requested location. A similar event 2036 may indicate the buyer is on his way. Events 2034 and 2036 may update periodically with currently locations and both the buyer and agent applications 2004, 2006 are notified with updated statuses. After confirmations, the agent is expected to proceed to the property location, meet the buyer, and show the property. Either party may cancel the request at any point.

If the agent cancel, event 2038 indicates the buyer being notified of the request cancellation. The buyer may opt to find another agent to show the property, returning the sequence 2000 to event 2010. Event 2040 may indicate the notification to the buyer that the agent has canceled the request. If the agent does not show up at the property, the buyer may indicate the agent did not show up for the showing without canceling. The buyer may report that the agent did not show up at event 2042. At event 2046, the request for a showing may be cancelled. Buyer actions are executed via or using customer application 2004.

As shown, a cancellation message may be sent from the server 2002 to the agent's electronic device. At event 2048, an additional event is requested. In 2048, a message may be sent from the agent's electronic device to the server 2002 requesting information about the event status. The request may seek event identification. The event may be an indication that the agent has accepted the customer's request for a showing, but that the requesting buyer cannot be located. At event 2050, the server 2002 notifies the buyer's electronic device that the request in question has been cancelled.

The buyer may report from the buyer's application 2004 to the server 2002 indicating that the real estate agent has arrived to provide the requested showing. The server 2002 may then log all the data for analytics and close the showing request, 2054, 2056 and 2058. The agent may send a message to the server 2002 to confirm that the buyer has met the agent in person. The agent shows the requested property to the buyer and the buyer's request for a showing may be closed.

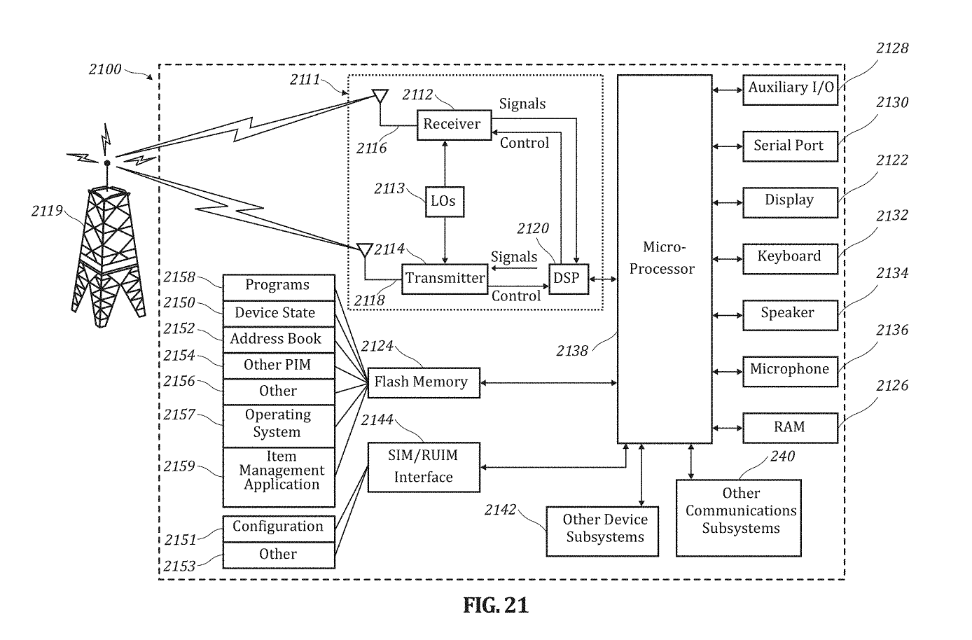

Referring to FIG. 21, a block diagram of an electronic device in accordance with an exemplary implementation is illustrated. As shown, the electronic device 2100 includes a microprocessor 2138 that controls the operation of the electronic device 2100. A communication subsystem 2111 performs all communication transmission and reception with the wireless network 2119. The microprocessor 2138 further may be communicatively coupled with an auxiliary input/output (I/O) subsystem 2128, which may be communicatively coupled to the electronic device 2100. Additionally, in at least one implementation, the microprocessor 2138 may be communicatively coupled to a serial port (for example, a Universal Serial Bus port) 2130 which may allow for communication with other devices or systems via the serial port 2130. A display 2122 may be communicatively coupled to microprocessor 2138 to allow for displaying of information to an operator of the electronic device 2100. When the electronic device 2100 is equipped with the keyboard 2132, the keyboard may also be communicatively coupled with the microprocessor 2138. The electronic device 2100 may include a speaker 2134, a microphone, 2136, random access memory (RAM) 2126, and flash memory 2124, all of which may be communicatively coupled to the microprocessor 2138. Other similar components may be provided on the electronic device 2100 as well and optionally communicatively coupled to the microprocessor 2138. Other communication subsystems 2140 and other electronic device subsystems 2142 are generally indicated as being functionally connected with the microprocessor 2138 as well. An example of a communication subsystem 2140 is that of a short range communication system such as BLUETOOTH® communication module or a WI-FI® communication module (a communication module in compliance with IEEE 802.11b) and associated circuits and components. Additionally, the microprocessor 2138 is able to perform operating system functions and enables execution of programs on the electronic device 2100. In some implementations not all of the above components may be included in the electronic device 2100. For example, in at least one implementation, the keyboard 2132 is not provided as a separate component and is instead integrated with a touchscreen as described below.

Furthermore, the electronic device 2100 is equipped with components to enable operation of various programs, as shown in FIG. 21. In an exemplary implementation, the flash memory 2124 is enabled to provide a storage location for the operating system 2157, device programs 2158, and data. The operating system 2157 is generally configured to manage other programs 2158 that are also stored in memory 2124 and executable on the microprocessor 2138. The operating system 2157 honors requests for services made by programs 2158 through predefined program 2158 interfaces. More specifically, the operating system 2157 typically determines the order in which multiple programs 2158 are executed on the microprocessor 2138 and the execution time allotted for each program 2158, manages the sharing of memory 2124 among multiple programs 2158, handles input and output to and from other device subsystems 2142, and so on. In addition, operators may typically interact directly with the operating system 2157 through a user interface usually including the keyboard 2132 and display screen 2122. While in an exemplary implementation the operating system 2157 is stored in flash memory 2124, the operating system 2157 in other implementations is stored in read-only memory (ROM) or similar storage element (not shown). As those skilled in the art will appreciate, the operating system 2157, device program 2158 or parts thereof may be loaded in RAM 2126 or other volatile memory.

When the electronic device 2100 is enabled for two-way communication within the wireless communication network 2119, the electronic device 2100 may send and receive signals from a mobile communication service. Examples of communication systems enabled for two-way communication include, but are not limited to, the General Packet Radio Service (GPRS) network, the Universal Mobile Telecommunication Service (UMTS) network, the Enhanced Data for Global Evolution (EDGE) network, the Code Division Multiple Access (CDMA) network, High-Speed Packet Access (HSPA) networks, Universal Mobile Telecommunication Service Time Division Duplexing (UMTS-TDD), Ultra Mobile Broadband (UMB) networks, Worldwide Interoperability for Microwave Access (WiMAX), and other networks that may be used for data and voice, or just data or voice. For the systems listed above, the electronic device 2100 may use a unique identifier to enable the electronic device 2100 to transmit and receive signals from the communication network 2119. Other systems may operate without such identifying information. GPRS, UMTS, and EDGE use a smart card such as a Subscriber Identity Module (SIM) in order to allow communication with the communication network 2119. Likewise, most CDMA systems use a Removable User Identity Module (RUIM) in order to communicate with the CDMA network. A smart card may be used in multiple different electronic devices 2100. The electronic device 2100 may perform some operations without a smart card, but the electronic device 2100 may not be able to communicate with the network 2119. A smart card interface 2144 located within the electronic device 2100 allows for removal or insertion of a smart card (not shown). The smart card features memory and holds key configurations 2151, and other information 2153 such as identification and subscriber related information. With a properly enabled electronic device 2100, two-way communication between the electronic device 2100 and communication network 2119 is possible.

If the electronic device 2100 is enabled as described above or the communication network 2119 does not require such enablement, the two-way communication enabled electronic device 2100 is able to both transmit and receive information from the communication network 2119. The transfer of communication may be from the electronic device 2100 or to the electronic device 2100. In order to communicate with the communication network 2119, the electronic device 2100 in the presently described exemplary implementation is equipped with an integral or internal antenna 2118 for transmitting signals to the communication network 2119. Likewise the electronic device 2100 in the presently described exemplary implementation is equipped with another antenna 2116 for receiving communication from the communication network 2119. These antennae (2116, 2118) in another exemplary implementation are combined into a single antenna (not shown). As one skilled in the art would appreciate, the antenna or antennae (2116, 2118) in another implementation are externally mounted on the electronic device 2100.

When equipped for two-way communication, the electronic device 2100 features the communication subsystem 2111. As is understood in the art, the communication subsystem 2111 is modified so that the communication subsystem 2111 may support the operational needs of the electronic device 2100. The subsystem 2111 includes a transmitter 2114 and receiver 2112 including the associated antenna or antennae (2116, 2118) as described above, local oscillators (LOs) 2113, and a processing module 2120, which in the presently described exemplary implementation is a digital signal processor (DSP) 2120.

Communication by the electronic device 2100 with the wireless network 2119 may be any type of communication that both the wireless network 2119 and electronic device 2100 are enabled to transmit, receive and process. In general, the communication may be classified as voice and data. Voice communication generally refers to communication in which signals for audible sounds are transmitted by the electronic device 2100 through the communication network 2119. Data generally refers to all other types of communication that the electronic device 2100 is capable of performing within the constraints of the wireless network 2119.

The keyboard 2132 may include a plurality of keys that may be of a physical nature such as actuable buttons, or the plurality of keys may be of a software nature, typically constituted by virtual representations of physical keys on the display screen 2122 (referred to herein as “virtual keys”). The user input may be provided as a combination of the two types of keys. Each key of the plurality of keys may have at least one actuable action, which may be the input of indicia such as a character, a command or a function. “Characters” are contemplated to exemplarily include alphabetic letters, language symbols, numbers, punctuation, insignias, icons, pictures, and even a blank space.

In the case of virtual keys, the indicia for the respective keys are shown on the display screen 2122, which in one implementation is enabled by touching the display screen 2122, for example, with a stylus, finger, or other pointer, to generate the character or activate the indicated command or function. Some examples of display screens 2122 capable of detecting a touch include resistive, capacitive, projected capacitive, infrared and surface acoustic wave (SAW) touchscreens.

Physical and virtual keys may be combined in many different ways as appreciated by those skilled in the art. In one implementation, physical and virtual keys are combined such that the plurality of enabled keys for a particular program or feature of the electronic device 2100 is shown on the display screen 2122 in the same configuration as the physical keys. Using the configuration just described, the operator may select the appropriate physical key corresponding to what is shown on the display screen 2122. Thus, the desired character, command or function is obtained by depressing the physical key corresponding to the character, command or function displayed at a corresponding position on the display screen 2122, rather than touching the display screen 2122.

While the above description generally describes the systems and components associated with a handheld electronic device, the electronic device 2100 could be another electronic device such as a PDA, a laptop computer, desktop computer, a server, or other electronic device. The electronic device 2100 may comprise different components or the above system might be omitted in order to provide the desired electronic device 2100. Additionally, other components not described above may be used to allow the electronic device 2100 to function in a desired fashion. The above description provides only general components and additional components may be used to enable the system to function. The additional systems and components would be appreciated by those of ordinary skill in the art.

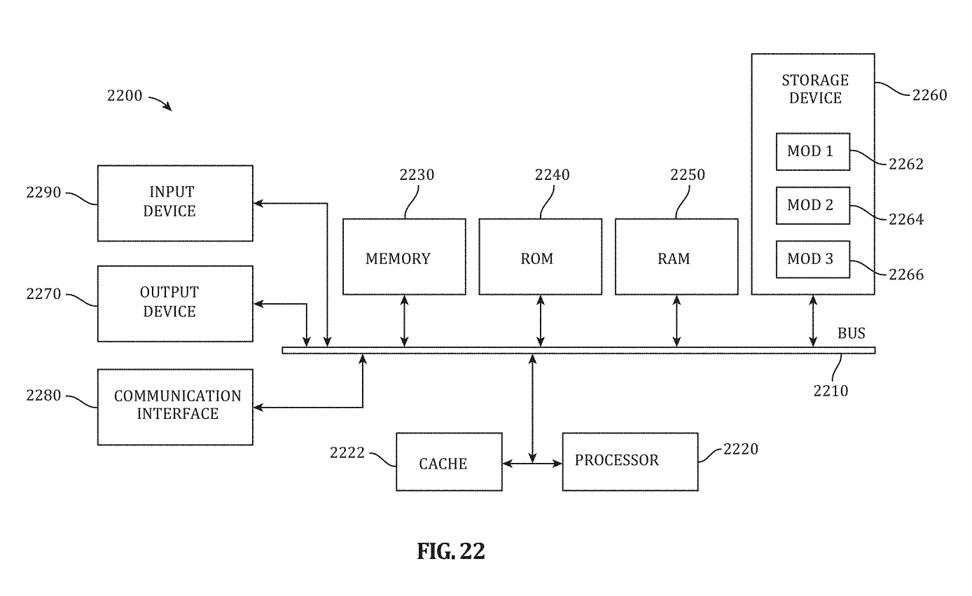

With reference to FIG. 22, an exemplary system and/or computing device 2200 includes a processing unit (for example, a central processing unit (CPU) or processor) 2220 and a system bus 2210 that couples various system components, including the system memory 2230 such as read only memory (ROM) 2240 and random access memory (RAM) 2250, to the processor 2220. The computing 2200 may include a cache 2222 of high-speed memory connected directly with, in close proximity to, or integrated as part of the processor 2220. The computing device 2200 may copy data from the memory 2230 and/or the storage device 2260 to the cache 2222 for access by the processor 2220. These and other modules may control or be configured to control the processor 2220 to perform various operations or actions. The memory 2230 may include multiple different types of memory with different performance characteristics.

Multiple processors or processor cores may share resources such as memory 2230 or the cache 2222, or may operate using independent resources. The processor 2220 may include one or more of a state machine, an application specific integrated circuit (ASIC), or a programmable gate array (PGA) including a field PGA. The system bus 2210 may be any of several types of bus structures including a memory bus or memory controller, a peripheral bus, and a local bus using any of a variety of bus architectures. A basic input/output (BIOS) stored in ROM 2240 or the like, may provide the basic routine that helps to transfer information between elements within the computing device 2200, such as during start-up.

The computing device 2200 may further include storage devices 260 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. The storage device 2260 may include software modules 2262, 2264, 2266 for controlling the processor 2220. The computing device 2200 may include other hardware or software modules. Although the exemplary embodiment(s) described herein employs the hard disk as storage device 2260, other types of computer-readable storage devices which may store data that are accessible by a computer, such as magnetic cassettes, flash memory cards, digital versatile disks (DVDs), cartridges, random access memories (RAMs) 2250, read only memory (ROM) 2240, a cable containing a bit stream and the like may also be used in the exemplary operating environment. Tangible computer-readable storage media, computer-readable storage devices, or computer-readable memory devices, expressly exclude media such as transitory waves, energy, carrier signals, electromagnetic waves, and signals per se.

The basic components and appropriate variations may be modified depending on the type of device, such as whether the computing device 2200 is a small, handheld computing device, a desktop computer, or a computer server. When the processor 2220 executes instructions to perform “operations”, the processor 2220 may perform the operations directly and/or facilitate, direct, or cooperate with another device or component to perform the operations.

To enable user interaction with the computing device 2200, an input device 2290 represents any number of input mechanisms, such as a microphone for speech, a touch-sensitive screen for gesture or graphical input, keyboard, mouse, motion input, speech and so forth. An output device 2270 may also be one or more of a number of output mechanisms known to those of skill in the art. In some instances, multimodal systems enable a user to provide multiple types of input to communicate with the computing device 2200. The network communications interface 2280 generally governs and manages the user input and system output. There is no restriction on operating on any particular hardware arrangement and therefore the basic hardware depicted may easily be substituted for improved hardware or firmware arrangements as they are developed.

One or more parts of the example computing device 2200, up to and including the entire computing device 2200, may be virtualized. For example, a virtual processor may be a software object that executes according to a particular instruction set, even when a physical processor of the same type as the virtual processor is unavailable.

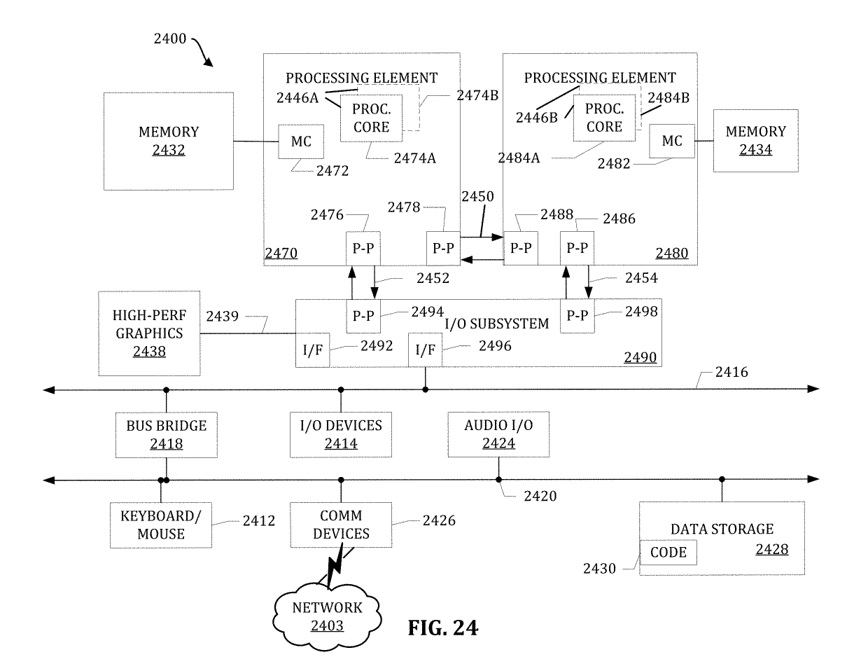

Referring now to FIG. 24, a block diagram illustrates a programmable device 2400 that may be used within web server 202, gateway device 204, or client 208 in accordance with one embodiment. The programmable device 2400 illustrated in FIG. 24 is a multiprocessor programmable device that includes a first processing element 2470 and a second processing element 2480. While two processing elements 2470 and 2480 are shown, an embodiment of programmable device 2400 may also include only one such processing element.

Programmable device 2400 is illustrated as a point-to-point interconnect system, in which the first processing element 2470 and second processing element 2480 are coupled via a point-to-point interconnect 2450. Any or all of the interconnects illustrated in FIG. 24 may be implemented as a multi-drop bus rather than point-to-point interconnects.

As illustrated in FIG. 24, each of processing elements 2470 and 2480 may be multicore processors, including first and second processor cores (i.e., processor cores 2474a and 2474b and processor cores 2484a and 2484b). Such cores 2474a, 2474b, 2484a, 2484b may be configured to execute instruction code in a manner similar to that discussed above in connection with FIGS. 1-3A. However, other embodiments may use processing elements that are single core processors as desired. In embodiments with multiple processing elements 2470, 2480, each processing element may be implemented with different numbers of cores as desired.

Each processing element 2470, 2480 may include at least one shared cache 2446. The shared cache 2446a, 2446b may store data (e.g., instructions) that are utilized by one or more components of the processing element, such as the cores 2474a, 2474b and 2484a, 2484b, respectively. For example, the shared cache may locally cache data stored in a memory 2432, 2434 for faster access by components of the processing elements 2470, 2480. In one or more embodiments, the shared cache 2446a, 2446b may include one or more mid-level caches, such as level 2 (L2), level 3 (L3), level 4 (L4), or other levels of cache, a last level cache (LLC), or combinations thereof.

While FIG. 24 illustrates a programmable device with two processing elements 2470, 2480 for clarity of the drawing, the scope of the present invention is not so limited and any number of processing elements may be present. Alternatively, one or more of processing elements 2470, 2480 may be an element other than a processor, such as an graphics processing unit (GPU), a digital signal processing (DSP) unit, a field programmable gate array, or any other programmable processing element. Processing element 2480 may be heterogeneous or asymmetric to processing element 2470. There may be a variety of differences between processing elements 2470, 2480 in terms of a spectrum of metrics of merit including architectural, microarchitectural, thermal, power consumption characteristics, and the like. These differences may effectively manifest themselves as asymmetry and heterogeneity amongst processing elements 2470, 2480. In some embodiments, the various processing elements 2470, 2480 may reside in the same die package.

First processing element 2470 may further include memory controller logic (MC) 2472 and point-to-point (P-P) interconnects 2476 and 2478. Similarly, second processing element 2480 may include a MC 2482 and P-P interconnects 2486 and 2488. As illustrated in FIG. 24, MCs 2472 and 2482 couple processing elements 2470, 2480 to respective memories, namely a memory 2432 and a memory 2434, which may be portions of main memory locally attached to the respective processors. While MC logic 2472 and 2482 is illustrated as integrated into processing elements 2470, 2480, in some embodiments the memory controller logic may be discreet logic outside processing elements 2470, 2480 rather than integrated therein.

Processing element 2470 and processing element 2480 may be coupled to an I/O subsystem 2490 via respective P-P interconnects 2476 and 2486 through links 2452 and 2454. As illustrated in FIG. 24, I/O subsystem 2490 includes P-P interconnects 2494 and 2498. Furthermore, I/O subsystem 2490 includes an interface 2492 to couple I/O subsystem 2490 with a high performance graphics engine 2438. In one embodiment, a bus (not shown) may be used to couple graphics engine 2438 to I/O subsystem 2490. Alternately, a point-to-point interconnect 2439 may couple these components.

In turn, I/O subsystem 2490 may be coupled to a first link 2416 via an interface 2496. In one embodiment, first link 2416 may be a Peripheral Component Interconnect (PCI) bus, or a bus such as a PCI Express bus or another I/O interconnect bus, although the scope of the present invention is not so limited.

As illustrated in FIG. 24, various I/O devices 2414, 2424 may be coupled to first link 2416, along with a bridge 2418 which may couple first link 2416 to a second link 2420. In one embodiment, second link 2420 may be a low pin count (LPC) bus. Various devices may be coupled to second link 2420 including, for example, a keyboard/mouse 2412, communication device(s) 2426 (which may in turn be in communication with the computer network 2403), and a data storage unit 2428 such as a disk drive or other mass storage device which may include code 2430, in one embodiment. The code 2430 may include instructions for performing embodiments of one or more of the techniques described above. Further, an audio I/O 2424 may be coupled to second bus 2420.

Note that other embodiments are contemplated. For example, instead of the point-to-point architecture of FIG. 24, a system may implement a multi-drop bus or another such communication topology. Although links 2416 and 2420 are illustrated as busses in FIG. 24, any desired type of link may be used. Also, the elements of FIG. 24 may alternatively be partitioned using more or fewer integrated chips than illustrated in FIG. 24.

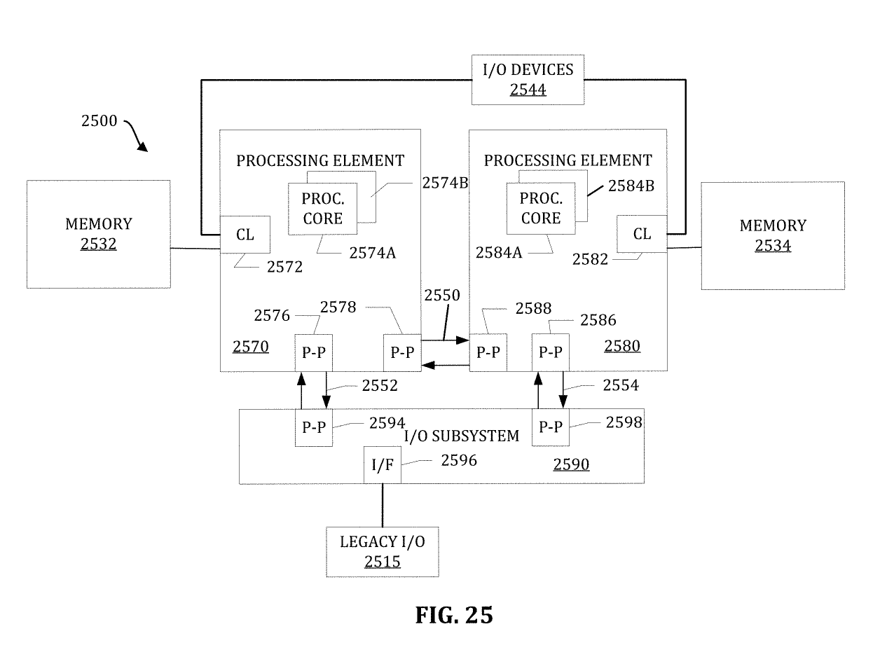

Referring now to FIG. 25, a block diagram illustrates a programmable device 2500 according to another embodiment. Certain aspects of FIG. 24 have been omitted from FIG. 25 in order to avoid obscuring other aspects of FIG. 25.

FIG. 25 illustrates that processing elements 2570, 2580 may include integrated memory and control logic 2572 and 2582, respectively. In some embodiments, the 2572, 2582 may include memory control logic (MC) such as that described above in connection with FIG. 24. In addition, CL 2572, 2582 may also include I/O control logic. FIG. 25 illustrates that not only may the memories 2532, 2534 be coupled to the 2572, 2582, but also that I/O devices 2544 may also be coupled to the control logic 2572, 2582. Legacy I/O devices 2515 may be coupled to the I/O subsystem 2590 by interface 2596. Each processing element 2570, 2580 may include multiple processor cores, illustrated in FIG. 5 as processor cores 2574A, 2574B, 2584A, and 2584B. As illustrated in FIG. 25, I/O subsystem 2590 includes P-P interconnects 2594 and 2598 that connect to P-P interconnects 2576 and 2586 of the processing elements 2570 and 2580 with links 2552 and 2554. Processing elements 2570 and 2580 may also be interconnected by link 2550 and interconnects 2578 and 2588, respectively.

The programmable devices depicted in FIGS. 24 and 25 are schematic illustrations of embodiments of programmable devices which may be utilized to implement various embodiments discussed herein. Various components of the programmable devices depicted in FIGS. 24 and 25 may be combined in a system-on-a-chip (SoC) architecture.

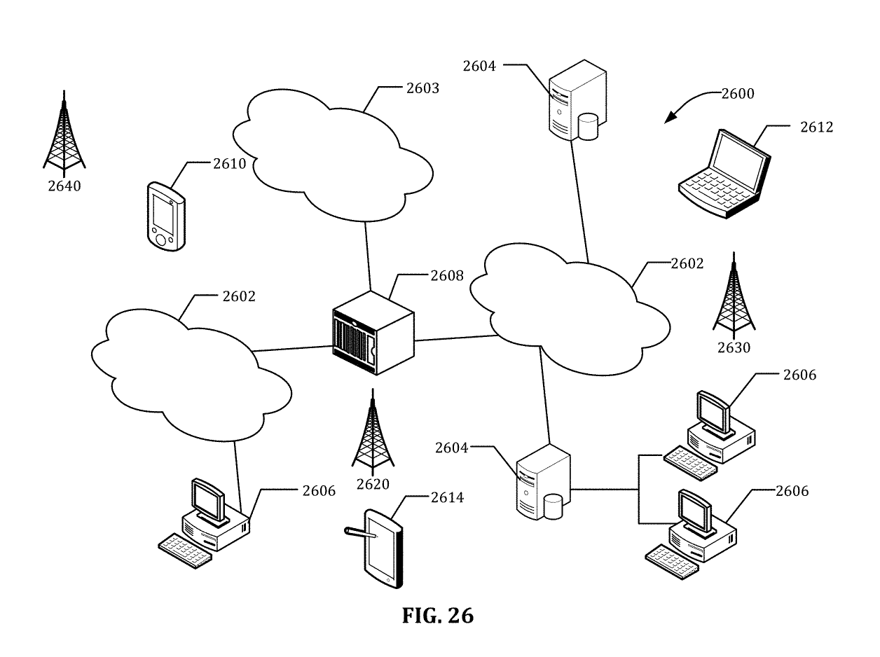

Referring now to FIG. 26, an example infrastructure 2600 in which the techniques described above may be implemented is illustrated schematically. Infrastructure 2600 contains computer networks 2602. Computer networks 2602 may include many different types of computer networks available today, such as the Internet, a corporate network, or a Local Area Network (LAN). Each of these networks can contain wired or wireless programmable devices and operate using any number of network protocols (e.g., TCP/IP). Networks 2602 may be connected to gateways and routers (represented by 2608), end user computers 2606, and computer servers 2604. Infrastructure 2600 also includes cellular network 2603 for use with mobile communication devices. Mobile cellular networks support mobile phones and many other types of mobile devices. Mobile devices in the infrastructure 2600 are illustrated as mobile phones 2610, laptops 2612, and tablets 2614. A mobile device such as mobile phone 2610 may interact with one or more mobile provider networks as the mobile device moves, typically interacting with a plurality of mobile network towers 2620, 2630, and 2640 for connecting to the cellular network 2603. Although referred to as a cellular network in FIG. 26, a mobile device may interact with towers of more than one provider network, as well as with multiple non-cellular devices such as wireless access points and routers 2608. In addition, the mobile devices 2610, 2612, and 2614 may interact with non-mobile devices such as computers 2604 and 2606 for desired services, which may include providing the application, script, or web content in web pages to a secure enclave module described above. The functionality of the computing device 2200 or electronic device 2100 or server 2002 may be implemented in any device or combination of devices illustrated in FIG. 26.

At least one method is a method of establishing a relationship between a client and a real estate agent. The method may comprise the following steps: receiving a request from a client; determining a location of the client making the request; locating real estate agents within a first predetermined distance of the location; calculating the proximity of each of the real estate agents to the location; notifying the most proximate real estate agent of the client's request; waiting a predetermined amount of time for an affirmative response from the most proximate real estate agent; determining whether an affirmative response has been received from the most proximate real estate agent; if an affirmative response has been received, notifying the client that the affirmative response has been received and notifying the client of the affirmatively responding real estate agent's identity; if an affirmative response has not been received, notifying the next most proximate real estate agent of the client's request; waiting a predetermined amount of time for an affirmative response from the next most proximate real estate agent; determining whether an affirmative response has been received from the next most proximate real estate agent; if an affirmative response has been received, notifying the client that the affirmative response has been received and notifying the client of the affirmatively responding real estate agent's identity; if an affirmative response has not been received, notifying the next most proximate real estate agent of the client's request; repeating steps j through m until all real estate agents within the predetermined distance until all the located real estate agents have been notified and a determination has been as to whether an affirmative response has been received from each.

In at least one embodiment, an electronic device may be used to capture and record information about a given property. Such captured information may include, but is not limited to asking price, square footage, and number of bedrooms. Such captured information may also include, but is not limited to information about schools near the property and crime data/statistics for the neighborhood in which the property is located. In at least one embodiment, a client-user may be enabled to post an opinion about the property, (for example, “Hot” or “Not Hot”). A user may also be enabled to store photographic data or audio data or both pertaining to the property. A user may also be enabled to enter notes about a given property via a textual input mechanism running an application described herein. A user may also be enabled to share information about the property or about an agent via a social network system, such as FACEBOOK™ or PINTEREST™, for example. (FACEBOOK is a registered trademark of Facebook, Inc.)

In at least one embodiment, agents (e.g., real estate agents) may be enabled to register to participate within the system. The registration system may use email and/or text message confirmation to encourage registration, which may encourage and enable participation. Registration of users may utilize ecommerce checkout and have an automatically recurring billing cycle. Registration may include requiring users to agree to certain appropriate terms conditions. Registration may include requiring users to execute a service level agreement.

In at least one embodiment, a dashboard may be displayed on a real estate agent's device. The dashboard may be configured to list any pending requests for showings as described above. The dashboard may also be configured to display a list of the real estate agent's most recent showings. The dashboard may also include a navigation bar which may link the real estate agent to various features. At least one feature may be a buyer contact list. Within this feature, once an agent connects with a buyer, the buyers name, preferences and contact info are stored in in the agent's buyer contact list. Agents may directly call, text or email buyers from this list. Agents may see a list of properties shown to each buyer and any notes taken during the showing. At least one feature is the option to prevent the system from sending any showing requests from a specific user to the agent. The dashboard may also be configured to display additional information to the agent. Such additional information may include, but is not limited to, the number of showing requests for a predetermined or agent-user specified area, the number of showing requests within a specific period (for example a week or a month), the total number of showing made or requested for a certain property or certain area, or made and requested for a certain property or certain area. The dashboard may also be configured to display information about the number of showing requests for which a response was not received, for a given location or area within a specific period. The dashboard may also be configured to display the number of showing requests that were made during “off” hours. The dashboard may also be configured to display a list of users of the system. The dashboard may also enable an agent to enter an “unavailable mode” in which showing requests send to the agent are automatically declined. In at least one embodiment, showing requests may be tracked, even when the agent is “unavailable.” In at least one embodiment, the dashboard may be configured not to present showing request notifications during specific periods.

In at least one embodiment, an agent may be enabled to establish an agent profile, in which an agent may input, and cause to be shared, personal information, avatar pictures, Multiple Listing Service (MLS) access information, and other relevant information.

In at least one embodiment, an administrator of a system used by clients and real estate agents may be enabled to perform various functions and access relevant information. Thus the administrator is provided with the ability to manage key functions of their system. For example, the system may be configured to display usage statistics of selected agents. The system may be configured to add agents manually, thereby circumventing the ecommerce signup process. The system may be configured to enable an administrator to suspend an agent from using the system and may enable an administrator to delete agents from the system entirely. The system may also be configured to display usage statistics of selected agents and to enable the administrator to suspend or delete buyers from the system. The system may also be configured to enable the administrator to establish periods in which a given client or real estate agent may use the system without paying a fee. The system may also enable the administrator to adjust and amend the algorithms discussed above. The system may also be configured to provide the administrator with information pertaining to buyer activity and agent activity. The system may also include one or more algorithms to evaluate performance and responsiveness of agents. Such algorithms could track information such as, how often agents confirm availability for a showing within a specified period after a showing request has been made, (for example, in the first thirty seconds, sixty seconds). Such algorithms may also track data about the number of agents being notified within a certain period after a showing request has been made, (for example, how many agents, on average, are notified who are within ten minutes of fifteen minutes).

Examples within the scope of the present disclosure may also include tangible and/or non-transitory computer-readable storage media for carrying or having computer-executable instructions or data structures stored thereon. Such non-transitory computer-readable storage media may be any available media that may be accessed by a general purpose or special purpose computer, including the functional design of any special purpose processor as discussed above. By way of example, and not limitation, such non-transitory computer-readable media may include RAM, ROM, EEPROM, CD-ROM or other optical disk storage, magnetic disk storage or other magnetic storage devices, or any other medium which may be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In at least one embodiment, an application may include an MLS system for buyers having a direct interface with accurate information. The buyer's MLS may track a buyers interest in particular features of a specific property. This information may include the number of bedrooms, bathrooms, price, square footage, lot size, location, pool, school ratings, price per square foot, number of floors, or other property features. In at least one embodiment, an electronic device may acquire this information from web pages. In another embodiment, an electronic device may grab the screen and send it to a server to process and retrieve the information. The server may then send the retrieved information may back to the electronic device.

In at least one embodiment, an application may include an MLS system for buyers having a direct interface with accurate information. The buyer's MLS may track a property's specifications. This information may include the number of bedrooms, bathrooms, price, square footage, lot size, location, pool, school ratings, price per square foot, number of floors, or other property features. In at least one embodiment, an electronic device may acquire this information from web pages. In another embodiment, an electronic device may grab the screen and send it to a server to process and retrieve the information. The server may then send the retrieved information may back to the electronic device.

The application may allow users (buyers, renters, or agents) to create a virtual fence or boundary about a particular area that they are interested in. The application may inform a user of new listings, sales that have closed, rentals, foreclosures, etc. within the specified area. The application may also alert users to price changes within the area. In at least one embodiment, the application may include a photograph of the property in the alert. The application may further allow a user to request an agent to meet them at the property in response to the specific alert. In at least one embodiment, the request for an agent to meet at the property is an existing relationship with an agent. In other embodiments, the request for an agent to meet at the property is a new relationship.

The agent application 2006 and the customer application 2004 may further include built in mortgage calculators. The mortgage calculators may provide approximate mortgage payment calculations and property insurance approximations. These calculations may assist a client with budgeting, purchase price, and whether they would like to make an offer on a property. The mortgage calculator may generate a contract offer and send them via e-mail or other delivery means (for example ‘Docusign’) whereby the client may immediately attach and electronic signature via their electronic device. In at least one embodiment, an application may download appropriate forms, such as state promulgated forms, for completion by an agent. Completed forms may then be transferred to the client for signature and/or execution, and the signed and/or executed forms may be forwarded to the listing agent, thus enabling the client to make an offer to purchase the property in question immediately.

The agent application 2006 may include a gift or reward button. The button may allow a real estate agent send a predetermined gift to a client (user buyer or user renter) upon completion of a deal. The predetermined gift may be ordered from a predetermined vendor arranged by the application or the real estate agent. In at least one embodiment, the predetermined gift may be a fruit basket or flowers. The predetermined vendor may have a thank you card on file with a predetermined message and the agent's signature. The agent application 2006 may also send the predetermined vendor the address for the location where the property is located.

The agent application 2006 may further include a re-initialize contact feature. This feature may remind an agent to contact a client (i.e., buyer or renter) after a predetermined period without contact. In at least one embodiment, re-initialize contact feature may prompt an agent to contact a client after a 30 day quiet period. The application 2006 may integrate with a calendar on the electronic device to automatically include and schedule these reminders.

The application may include a referral system allowing agents to communicate with each other. The application may aggregate contact information for the agents allowing each to communicate with the other. This feature may allow a real estate agent to message another real estate agent about a specific client (i.e., buyer or renter), or refer them to a client in the event of a scheduling conflict or similar event. Additionally, the application may allow a client, using the customer application 2004, to refer a friend to a particular agent. In this arrangement, the friend may bypass locating an agent and skip straight to the referred agent.

The various embodiments described above are provided by way of illustration only and should not be construed to limit the scope of the disclosure. Various modifications and changes may be made to the principles described herein without following the example embodiments and applications illustrated and described herein, without departing from the scope of the disclosure.

What is claimed is:

1. A system comprising:
one or more processors;
one or more network communication interfaces; and
a memory communicatively coupled to the one or more processors, wherein the memory stores instructions that when executed cause at least some of the one or more processors to:
receive, from an electronic device associated with a user, a showing request for viewing a real-estate property;
identify one or more agents within a proximity to the real-estate property;
send information related to the showing request to at least one of the one or more agents responsive to identifying the one or more agents; and
determine that at least one acceptance is received for the showing request from the one or more agents; and
send a meeting notification to the electronic device responsive to determining that the showing request includes the at least one acceptance,
wherein the showing request includes at least a time estimate for viewing the real-estate property.

2. The system of claim 1, wherein the instructions further comprise instructions that when executed cause at least some of the one or more processors to retrieve GPS (global positioning system) information corresponding to the real-estate property and send the GPS information to the one or more agents.

3. The system of claim 1, wherein the instructions further comprise instructions that when executed cause at least some of the one or more processors to compare the real-estate property with other real-estate properties stored in a database of listings and send listings of similar real-estate properties to the electronic device.

4. The system of claim 1, wherein the instructions further comprise instructions that when executed cause at least some of the one or more processors to retrieve GPS data corresponding to the identified one or more agents and send the GPS data to the electronic device.

5. The system of claim 1, wherein the information on the showing request includes at least one of photographic and address information corresponding to the real-estate property.

6. The system of claim 1, wherein the instructions further comprise instructions that when executed cause at least some of the one or more processors to receive at least one additional acceptance of the showing request and determine which at least one acceptance from amongst a plurality of acceptances should be transmitted to the electronic device.

7. The system of claim 1, wherein the time estimate is one of travel time from the one or more agents providing the at least one acceptance to the showing request.

8. The system of claim 7, wherein the time estimate is an estimated time based on distance.

9. The system of claim 7, wherein the time estimate is an estimated time based on traffic congestion.

10. A non-transitory computer readable medium comprising instructions stored thereon that when executed cause at least one or more processors to:
receive, from an electronic device associated with a user, a showing request for viewing a real-estate property;
identify one or more agents within a proximity to the real-estate property;
send information related to the showing request to at least one of the one or more agents responsive to identifying the one or more agents;
determine that at least one acceptance is received from the one or more agents; and
send a meeting notification to the electronic device responsive to determining that the showing request includes the at least one acceptance,
wherein the meeting notification includes a time estimate for the showing request.

11. The non-transitory computer readable medium of claim 10, wherein the instructions further comprise instructions that when executed cause at least some of the one or more processors to retrieve GPS (global positioning system) information corresponding to the real-estate property and send the GPS information to the identified one or more agents.

12. The non-transitory computer readable medium of claim 10, wherein the instructions further comprise instructions that when executed cause at least some of the one or more processors to compare the real-estate property with other real-estate properties stored in a database of listings and send similar listings to the electronic device.

13. The non-transitory computer readable medium of claim 10, wherein the instructions further comprise instructions that when executed cause at least some of the one or more processors to retrieve GPS data corresponding to the identified one or more agents and send the GPS data to the electronic device.

14. The non-transitory computer readable medium of claim 10, wherein the information on the showing request includes at least one of photographic and address information corresponding to the real-estate property.

15. The non-transitory computer readable medium of claim 10, wherein the instructions further comprise instructions that when executed cause at least some of the one or more processors to receive at least one additional acceptance of the showing request and determine which of at least one acceptance from amongst a plurality of acceptances should be transmitted to the electronic device.

16. The non-transitory computer readable medium of claim 10, wherein the time estimate is one of travel time from the one or more agents providing the acceptance.

17. The non-transitory computer readable medium of claim 10, wherein the time estimate is an estimated time based on distance.

18. The non-transitory computer readable medium of claim 10, wherein the time estimate is an estimated time based on traffic congestion.

19. A system comprising:
one or more processors;
one or more network communication interfaces; and
a memory communicatively coupled to the one or more processors, wherein the memory stores instructions that when executed cause at least some of the one or more processors to:
transmit, from an electronic device associated with a user, information related to a showing request for viewing a real-estate property to one or more agents;
receive information related to a proximity of the one or more agents to the real-estate property;
select at least one agent from the one or more agents for viewing the real-estate property;
receive information whether the at least one agent has accepted to show the real-estate property; and
receive a meeting notification at the electronic device responsive to receiving the information that the at least one agent has accepted to show the real-estate property,
wherein the meeting notification includes a time estimate for the showing request.

20. The system of claim 19, wherein the instructions further comprise instructions that when executed cause at least some of the one or more processors to retrieve GPS (global positioning system) information corresponding to the real-estate property and transmit the GPS information to the one or more agents.

21. The system of claim 19, wherein the instructions further comprise instructions that when executed cause at least some of the one or more processors to retrieve information concerning other real-estate properties which are similar to the real-estate property.

22. The system of claim 19, wherein the instructions further comprise instructions that when executed cause at least some of the one or more processors to receive GPS data corresponding to the proximity of the one or more agents to the electronic device.

23. The system of claim 19, wherein the information on the showing request includes at least one of photographic information and address information corresponding to the real-estate property.

24. The system of claim 19, wherein the time estimate is travel time to the real-estate property for the at least one agent that has accepted to show the real-estate property.

25. The system of claim 24, wherein the travel time is an estimated time based on distance.

26. The system of claim 24, wherein the travel time is an estimated time based on traffic congestion.
